(19) United States
(12) Patent Application Publication
(10) Pub. No.: US 2021/0223750 A1
(43) Pub. Date: Jul. 22, 2021

(54) SYSTEMS AND METHODS OF ZONE-BASED CONTROL VIA HETEROGENEOUS BUILDING AUTOMATION SYSTEMS

(71) Applicant: Johnson Controls Technology Company, Auburn Hills, MI (US)

(72) Inventors: Sourabh Taranath Joshi, Mumbai (IN); Subrata Bhattacharya, Navi Mumbai (IN); Krishan Kumar Sharma, Pune (IN); Amol Sadashiv Patil, Pune (IN); Ankur Thareja, Alwar (IN); Ashok Sridharan, Tiruchirappalli (IN)

(73) Assignee: Johnson Controls Technology Company, Auburn Hills, MI (US)

(21) Appl. No.: 17/054,384

(22) PCT Filed: Sep. 10, 2018
(86) PCT No.: PCT/US2018/050249

§ 371 Date: Nov. 10, 2020

(30) Foreign Application Priority Data
May 11, 2018 (IN) 201821017786

(51) Int. Cl. G05B 19/042; G06F 21/31

(52) U.S. Cl. CPC G05B 19/042; G05B 2219/25011; G05B 2219/2614; G06F 21/31

(57) ABSTRACT

A method for zone-based control of devices within a building management system (BMS) includes receiving a request to control a zone in a building. The method includes identifying a plurality of available zones in the building. The method includes receiving a selection to control a first zone from the plurality of available zones. In response to the selection, the method includes generating a password to restrict control of at least one device in the first zone. The method includes transmitting the password to the user device. The method includes receiving, via the input interface of the zone device different from the user device, the password. The method includes authorizing, responsive to receipt of the password via the input interface of the zone device, control of the at least one device in the first zone.

### CROSS-REFERENCE TO RELATED PATENT APPLICATION

This application claims the benefit of and priority to Indian Provisional Patent Application No. 201821017786 filed May 11, 2018, the entire disclosure of which is incorporated by reference herein.

### BACKGROUND

The present disclosure relates generally to a building management system. The present disclosure relates more particularly to systems and methods for providing schedule-based zone access to building management system.

A building management system (BMS) is, in general, a system of devices configured to control, monitor, and manage equipment in or around a building or building area. A BMS can include a heating, ventilation, and air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include a variety of devices (e.g., HVAC devices, controllers, chillers, fans, sensors, etc.) configured to facilitate monitoring and controlling the building space.

Currently, many building management systems provide control of an entire facility, building, or other environment. For example, a building management system can be configured to monitor multiple buildings, each having HVAC systems, water system, lights, air quality, security, and/or any other aspect of the facility within the purview of the building management system. Some buildings may have several floors and each floor may be divided into a number of sections. Accordingly, building equipment and devices may be associated with a building, floor, and/or section.

Sections in a building containing various equipment and devices can be reserved or booked by users. However, as multiple users attempt to reserve or book these sections containing various equipment or devices and for various uses, it can become increasingly challenging to efficiently reserve such sections in a manner that conserves resource or device utilization.

### SUMMARY

One implementation of the present disclosure is directed to a system for schedule-based zone control of devices within a building management system (BMS). In some embodiments, the system includes a user device, a zone device and a controller. The user device includes at least one processor and a display. The zone device includes at least one processor and an input interface. The controller can be part of or interface with the building management system. The controller includes at least one processor. The controller receives, from the user device via a network, a request to control a zone in a building. The request includes at least one data structure formed from a date field, a time field, a location field, a zone type field, and a resource field. The controller identifies, responsive to the request, a plurality of available zones in the building. The controller receives, from the user device, a selection to control a first zone from the plurality of available zones. Responsive to the selection, the controller generates a password to restrict control of at least one device in the first zone. The controller transmits, to the user device, the password. The controller receives, via the input interface of the zone device different from the user device, the password, the zone device located in the first zone. Responsive to receipt of the password via the input interface of the zone device, the controller authorizes control of the at least one device in the first zone.

In some embodiments, the controller can retrieve, from a database, a policy for controlling the at least one device. The controller can execute the policy at a predetermined time interval prior to a start time indicated in the time field of the at least one data structure of the request. In some embodiments, the controller can generate a command to adjust a temperature set point for the first zone at a predetermined time interval prior to a start time indicated in the time field of the at least one data structure of the request.

In some embodiments, the controller can detect an occupancy level of the first zone. The controller can override a temperature set point responsive to the occupancy level exceeding a threshold established in a database for the first zone.

In some embodiments, the controller can generate a time interval based on a start time and an end time indicated by the time field of the at least one data structure of the request. The controller can authorize control of the at least one device responsive to receipt of the password via the input interface of the zone device at a time within the time interval.

In some embodiments, the controller can generate a time interval based on a start time and an end time indicated by the time field of the at least one data structure of the request. The controller can prevent control of the at least one device responsive to receipt of the password via the input interface of the zone device at a time outside the time interval.

In some embodiments, the resource field can indicate a projector, a computing device, a telecommunications device, or a printer. The controller can identify the plurality of available zones based on the resource field, the plurality of available zones satisfying the resource field. In some embodiments, the at least one device in the first zone comprises a projector, a motorized projector screen, a lighting device, a computing device, a temperature controller, a telecommunication device, or a printer.

In some embodiments, the controller can receive an occupancy indication for the request based on a calendar entry stored in a scheduling system separate from the building management system. The controller can identify, based on a predetermined occupancy limit stored in a database for each of a plurality of zones in the building, the plurality of available zones that satisfy the occupancy indication.

In some embodiments, the controller can receive, from the user device, a list of identifiers authorized to access the first zone during a time interval based on the date field and the time field provided in the at least one data structure. The controller can receive, from an access control panel at the first zone, an identifier responsive to a badge swipe at the access control panel during the time interval. The controller can determine the identifier matches the list of identifiers. Responsive to the determination, the controller can unlock a remotely controlled lock to allow access to the first zone.

One implementation of the present disclosure is directed to a method of schedule-based zone control of devices within a building management system (BMS). The method includes receiving, from a user device via a network, a request to control a zone in a building. The request includes at least one data structure formed from a date field, a time field, a location field, a zone type field, and a resource field. The method includes identifying a plurality of available zones in the building. The method includes receiving, from the user device, a selection to control a first zone from the plurality of available zones. In response to the selection, the method includes generating a password to restrict control of at least one device in the first zone. The method includes transmitting the password to the user device. The method includes receiving, via the input interface of the zone device different from the user device, the password. The zone device is located in the first zone. The method includes authorizing, responsive to receipt of the password via the input interface of the zone device, control of the at least one device in the first zone.

In some embodiments, the method includes retrieving, from a database, a policy for controlling the at least one device. The method can include executing the policy at a predetermined time interval prior to a start time indicated in the time field of the at least one data structure of the request.

In some embodiments, the method can include generating a command to adjust a temperature set point for the first zone at a predetermined time interval prior to a start time indicated in the time field of the at least one data structure of the request.

In some embodiments, the method can include detecting an occupancy level of the first zone. The method can include overriding a temperature set point responsive to the occupancy level exceeding a threshold established in a database for the first zone.

In some embodiments, the method can include generating a time interval based on a start time and an end time indicated by the time field of the at least one data structure of the request. The method can include authorizing control of the at least one device responsive to receipt of the password via the input interface of the zone device at a time within the time interval.

In some embodiments, the method can include generating a time interval based on a start time and an end time indicated by the time field of the at least one data structure of the request. The method can include preventing control of the at least one device responsive to receipt of the password via the input interface of the zone device at a time outside the time interval.

In some embodiments, the resource field indicates a projector, a computing device, a telecommunications device, or a printer. The method can include identifying the plurality of available zones based on the resource field, the plurality of available zones satisfying the resource field.

In some embodiments, the at least one device in the first zone includes a projector, a motorized projector screen, a lighting device, a computing device, a temperature controller, a telecommunication device, or a printer. In some embodiments, the method can include receiving an occupancy indication for the request based on a calendar entry stored in a scheduling system separate from the building management system. The method can include identifying, based on a predetermined occupancy limit stored in a database for each of a plurality of zones in the building, the plurality of available zones that satisfy the occupancy indication.

In some embodiments, the method can include receiving, from the user device, a list of identifiers authorized to access the first zone during a time interval based on the date field and the time field provided in the at least one data structure. The method can include receiving, from an access control panel at the first zone, an identifier responsive to a badge swipe at the access control panel during the time interval. The method can include determining the identifier matches the list of identifiers. The method can include unlocking, responsive to the determination, a remotely controlled lock to allow access to the first zone.

One implementation of the present disclosure is directed to a system for zone-based control of devices within a building management system (BMS). In some embodiments, the system includes a controller of a building management system. The controller includes at least one processor. The controller is configured to detect occupancy in a first zone of a plurality of zones in a building. The controller is configured to identify, based on the detection of the occupancy, a user identifier. The controller is configured to retrieve, from a database, a first policy established for the first zone and a second policy established for the user identifier. The controller is configured to combine the first policy with the second policy to generate a merged policy. The controller is configured to execute the merged policy to control at least one device in the first zone.

In some embodiments, the controller is configured to merge the first policy with the second policy by overriding a parameter in the second policy. In some embodiments, the controller is configured to set a temperature set point for the first zone based on the first policy. The controller is configured to identify a temperature increase for the first zone defined by the second policy responsive to detection of the occupancy. The controller is configured to execute the first policy to set a limit for the temperature increase defined by the second policy. The controller is configured to control the at least one device to increase the temperature set point based on the limit.

In some embodiments, the controller is further configured to detect a plurality of occupants in the first zone. The controller is configured to identify a plurality of user identifiers corresponding to the plurality of occupants detected in the first zone. The controller is configured to retrieve a plurality of policies corresponding to the plurality of user identifiers. The controller is configured to control the at least one device in the first zone in accordance with the plurality of policies.

In some embodiments, the controller is configured to merge the plurality of policies with the first policy to generate a merged policy. The controller is configured to control the at least one device responsive to the merged policy. In some embodiments, the controller is further configured to detect that at least one of the plurality of occupants exited the first zone. The controller is configure to identify at least one user identifier of the plurality of user identifiers corresponding to the at least one of the plurality of occupants that exited the first zone. The controller is configured to remove at least one of the plurality of policies corresponding to the at least one user identifier from the merged policy.

In some embodiments, the controller is further configured to generate a graphical user interface comprising at least one input box to receive at least one policy and at least one parameter.

In some embodiments, the controller is further configured to receive an electronic transaction responsive to a badge swipe at an access control panel at the first zone. The controller is configured to detect, based on the electronic transaction, occupancy in the first zone. The controller is configured to identify the user identifier based on the electronic transaction.

In some embodiments, the controller is further configured to receive an electronic transaction responsive to a one-time password input at a zone device at the first zone. The controller is configured to detect, based on the electronic transaction, occupancy in the first zone. The controller is configured to identify the user identifier based on the one-time password.

In some embodiments, the controller is further configured to identify, based on the first policy, a first lighting parameter for the first zone. The controller is configured to identify, based on the second policy, a second lighting parameter for the user identifier. The controller is configured to prior to generation of a lighting command to control the at least one device, determine that the second lighting parameter conflicts with the first lighting parameter. The controller is configured to adjust the second lighting parameter based on the first lighting parameter. The controller is configured to generate the lighting command with the adjusted second lighting parameter.

One implementation of the present disclosure is directed to a method for zone-based control of devices within a building management system (BMS). In some embodiments, the method includes detecting occupancy in a first zone of a plurality of zones in a building. The method includes identifying, based on the detection of the occupancy, a user identifier. The method includes retrieving, from a database, a first policy established for the first zone and a second policy established for the user identifier. The method includes combining the first policy with the second policy to generate a merged policy. The method includes executing the merged policy to control at least one device in the first zone.

In some embodiments, the method includes merging the first policy with the second policy by overriding a parameter in the second policy. In some embodiments, the method includes setting a temperature set point for the first zone based on the first policy. The method includes identifying a temperature increase for the first zone defined by the second policy responsive to detection of the occupancy. The method includes executing the first policy to set a limit for the temperature increase defined by the second policy. The method includes controlling the at least one device to increase the temperature set point based on the limit.

In some embodiments, the method includes detecting a plurality of occupants in the first zone. The method includes identifying a plurality of user identifiers corresponding to the plurality of occupants detected in the first zone. The method includes retrieving a plurality of policies corresponding to the plurality of user identifiers. The method includes controlling the at least one device in the first zone in accordance with the plurality of policies. In some embodiments, the method includes merging the plurality of policies with the first policy to generate a merged policy. The method includes controlling the at least one device responsive to the merged policy. In some embodiments, the method includes detecting that at least one of the plurality of occupants exited the first zone. The method includes identifying at least one user identifier of the plurality of user identifiers corresponding to the at least one of the plurality of occupants that exited the first zone. The method includes removing at least one of the plurality of policies corresponding to the at least one user identifier from the merged policy.

In some embodiments, the method includes generating a graphical user interface comprising at least one input box to receive at least one policy and at least one parameter. In some embodiments, the method includes receiving an electronic transaction responsive to a badge swipe at an access control panel at the first zone. The method includes detecting, based on the electronic transaction, occupancy in the first zone. The method includes identifying the user identifier based on the electronic transaction.

In some embodiments, the method includes receiving an electronic transaction responsive to a one-time password input at a zone device at the first zone. The method includes detecting, based on the electronic transaction, occupancy in the first zone. The method includes identifying the user identifier based on the one-time password.

In some embodiments, the method includes identifying, based on the first policy, a first lighting parameter for the first zone. The method includes identifying, based on the second policy, a second lighting parameter for the user identifier. The method includes prior to generation of a lighting command to control the at least one device, determining that the second lighting parameter conflicts with the first lighting parameter. The method includes adjusting the second lighting parameter based on the first lighting parameter. The method includes generating the lighting command with the adjusted second lighting parameter.

### BRIEF DESCRIPTION OF THE DRAWINGS

FIG. 1 is a drawing of a building equipped with a HVAC system, according to some embodiments.

FIG. 2 is a block diagram of a waterside system which can be used to serve the building of FIG. 1, according to some embodiments.

FIG. 3 is a block diagram of an airside system which can be used to serve the building of FIG. 1, according to some embodiments.

FIG. 4 is a block diagram of a building management system (BMS) which can be used to monitor and control the building of FIG. 1, according to some embodiments.

FIG. 5 is a block diagram of a system for schedule-based zone access and control of devices, which can be used to access the BMS of FIG. 4, according to some embodiments.

FIG. 6 is a diagram of a graphical user interface of a dashboard view for meeting room booking provided by the system depicted in FIG. 5, according to some embodiments.

FIG. 7 is a diagram of a graphical user interface of a room booking view provided by the system depicted in FIG. 5, according to some embodiments.

FIG. 8 is a diagram of a graphical user interface for zone selection provided by the system depicted in FIG. 5, according to some embodiments.

FIG. 9 is a diagram of a graphical user interface for location selection provided by the system depicted in FIG. 5, according to some embodiments.

FIG. 10 is a diagram of a graphical user interface for room booking provided by the system depicted in FIG. 5, according to some embodiments.

FIG. 11 is a diagram of a graphical user interface for resource booking provided by the system depicted in FIG. 5, according to some embodiments.

FIG. 12 is a diagram of a graphical user interface for search results for room and resource booking provided by the system depicted in FIG. 5, according to some embodiments.

FIG. 13 is a flowchart of a process for access control, according to some embodiments.

FIG. 14 is a flowchart of a process for comfort management, according to some embodiments.

FIG. 15 is a diagram of a graphical user interface for room lighting provided by the system depicted in FIG. 5, according to some embodiments.

FIG. 16 is a diagram of a graphical user interface for cafeteria requests by the system depicted in FIG. 5, according to some embodiments.

FIG. 17 is a diagram of a graphical user interface for room booking with cafeteria requests by the system depicted in FIG. 5, according to some embodiments.

FIG. 18 is a diagram of a graphical user interface for inputting policies to be executed by the system depicted in FIG. 5, according to some embodiments.

FIG. 19 is a flowchart of a process for inputting policies to be executed by the system depicted in FIG. 5, according to some embodiments.

FIG. 20 is a flowchart of a process for inputting temperature control policies to be executed by the system depicted in FIG. 5, according to some embodiments.

FIG. 21 is a flowchart of a process for inputting lighting control policies to be executed by the system depicted in FIG. 5, according to some embodiments.

FIG. 22 is a diagram of a graphical user interface for integrating contacts for use with the system depicted in FIG. 5, according to some embodiments.

FIG. 23 is a diagram of a graphical user interface for attendance tracking generated by the system depicted in FIG. 5, according to some embodiments.

FIG. 24 is a flow chart of a process for schedule-based comfort management provided by the system depicted in FIG. 5, according to some embodiments.

FIG. 25 is a flow chart of a process for schedule-based comfort management provided by the system depicted in FIG. 5, according to some embodiments.

FIG. 26 is a flow chart of a process for on demand based comfort management provided by the system depicted in FIG. 5, according to some embodiments.

FIG. 27 is a flow chart of a process for on demand based comfort management provided by the system depicted in FIG. 5, according to some embodiments.

FIG. 28 is a flow chart of a process for on demand based comfort management provided by the system depicted in FIG. 5, according to some embodiments.

FIG. 29 is a flowchart of a process for on controlling building facilities based on occupancy detection by the system depicted in FIG. 5, according to some embodiments.

FIG. 30 is a diagram of a graphical user interface for an application for controlling building facilities based on occupancy generated by the system depicted in FIG. 5, according to some embodiments.

FIG. 31 is a diagram of a graphical user interface for point discovery for controlling building facilities based on occupancy generated by the system depicted in FIG. 5, according to some embodiments.

FIG. 32 is a diagram of a graphical user interface for mapping used for controlling building facilities based on occupancy generated by the system depicted in FIG. 5, according to some embodiments.

FIG. 33 is a diagram of a graphical user interface for syncing used for controlling building facilities based on occupancy generated by the system depicted in FIG. 5, according to some embodiments.

FIG. 34 is a diagram of a graphical user interface for zone point mapping used for controlling building facilities based on occupancy generated by the system depicted in FIG. 5, according to some embodiments.

FIG. 35 is a diagram of a graphical user interface for zone point mapping used for controlling building facilities based on occupancy generated by the system depicted in FIG. 5, according to some embodiments.

FIG. 36 is a diagram of a graphical user interface for zone point mapping used for controlling building facilities based on occupancy generated by the system depicted in FIG. 5, according to some embodiments.

FIG. 37 is a diagram of a graphical user interface for occupancy density used for controlling building facilities based on occupancy generated by the system depicted in FIG. 5, according to some embodiments.

FIG. 38 is a diagram of a graphical user interface for controls used for controlling building facilities based on occupancy generated by the system depicted in FIG. 5, according to some embodiments.

FIG. 39 is a diagram of a graphical user interface for a dashboard generated by the system depicted in FIG. 5, according to some embodiments.

FIG. 40 is a diagram of a graphical user interface for announcements generated by the system depicted in FIG. 5, according to some embodiments.

FIG. 41 is a diagram of a graphical user interface for zone information generated by the system depicted in FIG. 5, according to some embodiments.

FIG. 42 is a diagram of a graphical user interface for a calendar generated by the system depicted in FIG. 5, according to some embodiments.

FIG. 43 is a diagram of a graphical user interface for contacts generated by the system depicted in FIG. 5, according to some embodiments.

FIG. 44 is a diagram of a graphical user interface for announcements generated by the system depicted in FIG. 5, according to some embodiments.

FIG. 45 is a diagram of a graphical user interface for a profile generated by the system depicted in FIG. 5, according to some embodiments.

FIG. 46 is a diagram of a graphical user interface for a dashboard generated by the system depicted in FIG. 5, according to some embodiments.

FIG. 47 is a diagram of a graphical user interface for a help desk generated by the system depicted in FIG. 5, according to some embodiments.

FIG. 48 is a diagram of a graphical user interface for a dashboard generated by the system depicted in FIG. 5, according to some embodiments.

FIG. 49 is a diagram of a graphical user interface for lighting generated by the system depicted in FIG. 5, according to some embodiments.

FIG. 50 is a diagram of a graphical user interface for a dashboard generated by the system depicted in FIG. 5, according to some embodiments.

FIG. 51 is a diagram of a graphical user interface for a visitor screen generated by the system depicted in FIG. 5, according to some embodiments.

### DETAILED DESCRIPTION

### Overview

Systems and methods of the present technical solution allow for an improved building solution with an intuitive platform to provide a specialized user experience to occupants, tenants or employees by allowing them to interact with different components of their work environment in an efficient, integrated manner. The present technical solutions includes features configured to improve activities that impact employees and becomes an interface to interact with the building devices and systems. For example, the system can leverage features such as employee comfort management, meeting room booking, attendance management, helpdesk, and contacts to perform zone management via heterogeneous building automation systems.

Referring generally to the FIGURES, a building management system (BMS) and various components thereof are shown, according to an exemplary embodiment. The BMS includes sensors, building equipment, a building controller, and a controller system.

### Building HVAC Systems and Building Management Systems

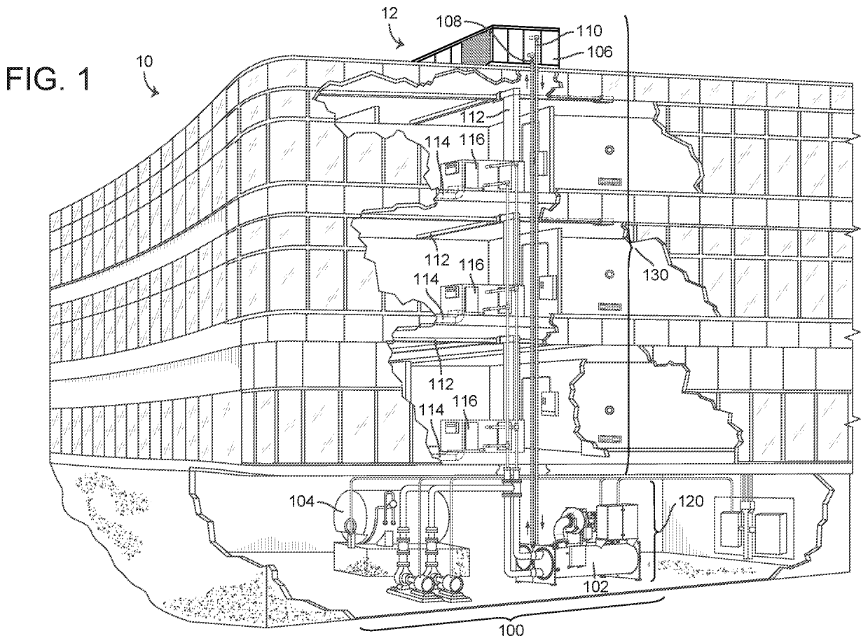

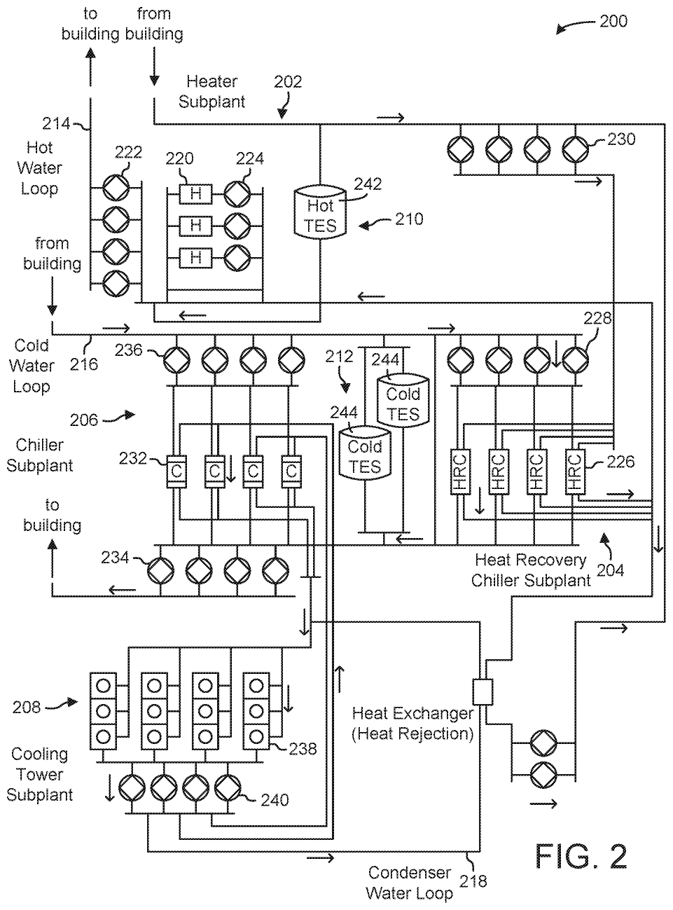

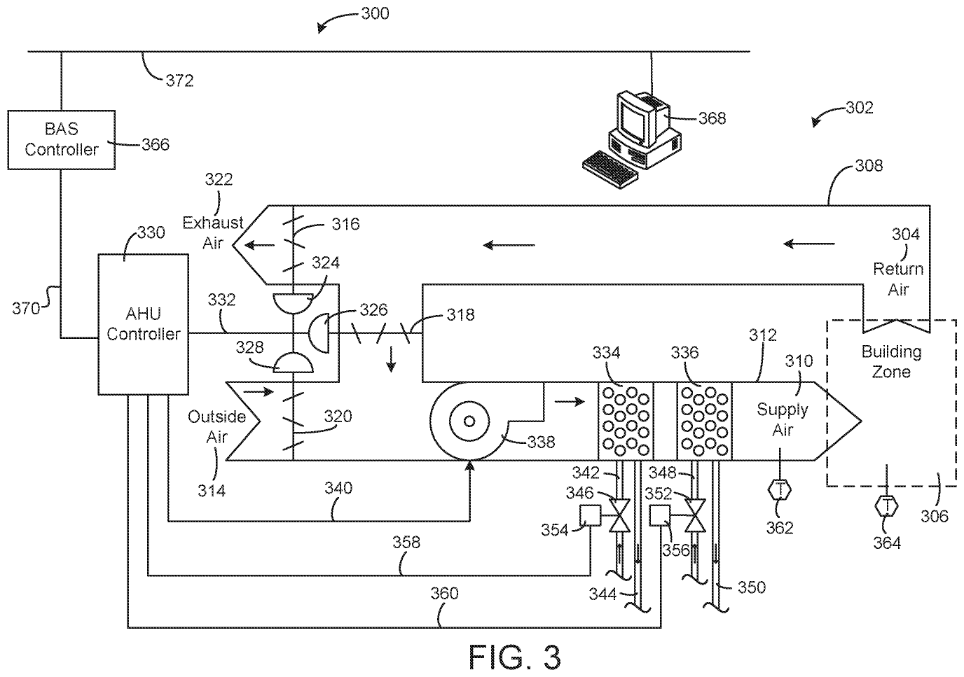

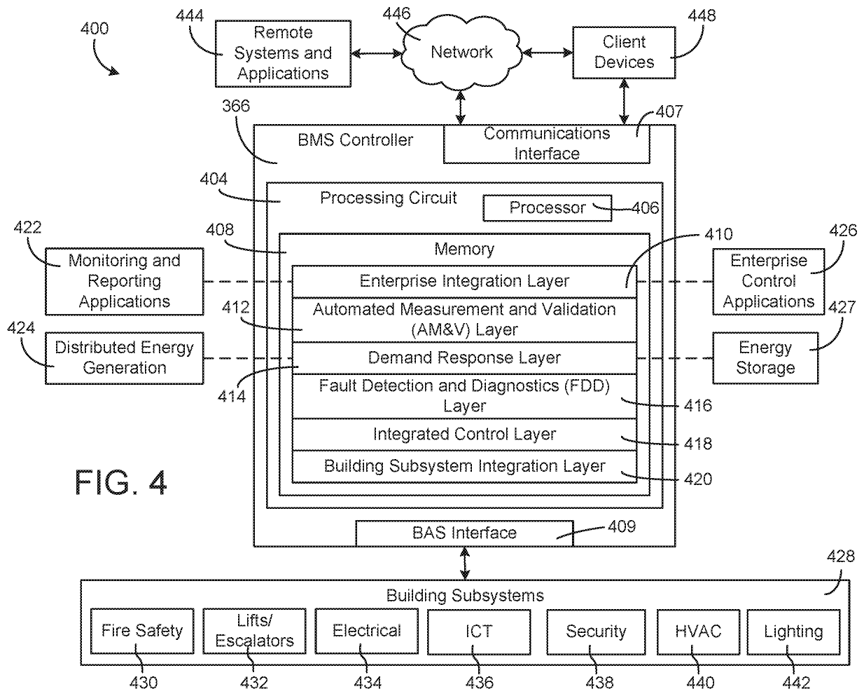

Referring now to FIGS. 1-4, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10.

### Building and HVAC System

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration layer 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify whether control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Systems and Methods of Schedule-Based Zone Access Via Heterogeneous Building Automation Systems

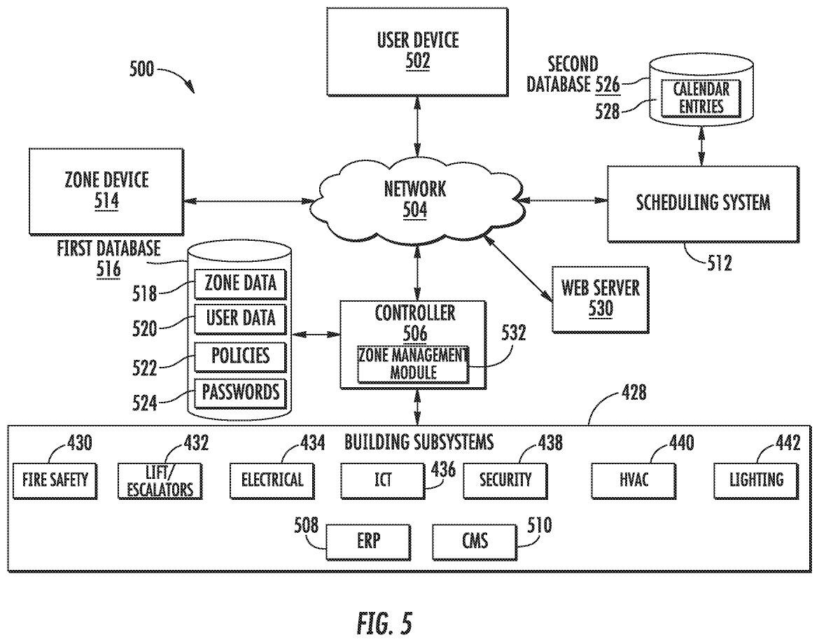

Referring now to FIGS. 5-51, systems and methods of schedule-based zone access via heterogeneous building automation systems are shown according to some embodiments. Systems and methods of the present technical solution allow for an improved building solution with an intuitive platform to provide a specialized user experience to occupants, tenants or employees by allowing them to interact with different components of their work environment in an efficient, integrated manner. The present technical solutions includes features configured to improve activities that impact employees and becomes an interface to interact with the building devices and systems. For example, the system can leverage features such as employee comfort management, meeting room booking, attendance management, helpdesk, and contacts to perform zone management via heterogeneous building automation systems.

Workplace management can impact the productivity of the employees and their health. An integrated management solution can allow users to book common spaces like meeting rooms on the floor and be able to manage functions related to the room booking through a unified interface. However, it can be challenging to efficiently book meeting rooms which are common and available to all in the following scenarios: meeting room to conduct meeting with team or visitors; one person occupying a bigger meeting room for his/her meeting making bigger teams wait/cancel/postpone their meeting; meeting rooms may not have required resources and employee has to go to admin team to raise requests and wait to receive them and then start meeting; in case participants of the meeting feel discomfort due to dull/inefficient lighting and hot/cold air conditioning then they have to speak to admin team to raise requests and wait for their response and action; people not invited for the meeting can still attend the meeting as there is no control to access the rooms as per the time booked; any person can come and attend the meeting. Accordingly, systems and methods of the present technical solution can provide a controller configured to provide schedule-based zone management via heterogeneous building automation systems in order to: book meeting rooms for a specific time period or recurring timing to conduct business meetings/interviews/customer visits, etc.; book meeting room as per room capacity and resources available; manage the lighting, air-conditioning, projector, etc. automatically based on room booking information; provide access to the meeting room only as per the meeting timing and successful authentication through an access control system for the room; raise food requests for the meeting to be conducted. Thus, the systems and methods of the present technical solution can efficiently and seamlessly provide meeting room booking along with the ability to perform functions related to lighting and HVAC management, cafeteria requests, etc.

The controller can provide a single interface through which users can book rooms, resources, etc. The controller, through the single unified interface, can allow users to carry out following functions: meeting room booking; resource booking; access control; comfort management—lighting & air-conditioning; cafeteria requests. To provide these features, the controller can integrate with heterogeneous systems including, for example: Building Management system, Access Control system, enterprise resource planning (“ERP”) system, cafeteria management system, and third party scheduling software. By integrating with these heterogeneous systems, the controller can facilitate users/occupants to book common areas for their meetings with required resources; manage comfort conditions as per their requirements and applicable efficiency or resource utilization rules; and allow invite-only, selective, or restricted access to the meeting through access control.

FIG. 5 is a block diagram of a schedule-based zone access system 500, which can be used to access the BMS of FIG. 4, according to some embodiments. As shown, a user device 502, a zone device 514, a web server 530, and a controller 506 may all send and receive information via network 504. In this way, for example, data may be exchanged among user device 502, zone device 514, web server 530, and controller 506. In some embodiments, controller 506 may be the same or similar to BAS controller 366, as described with respect to FIG. 4. Further, in some embodiments, network 504 may be the same or similar to network 446, as described with respect to FIG. 4. User device can include one or more component or functionality of client device 448. User device 502 may be, for example, a smartphone, smartwatch, laptop, desktop computer, tablet, or any other device configured to communicate via a wired or wireless network (e.g., network 504). The user device 502 can include at least one processor. The user device 502 can include memory, input ports, or output ports. The user device 502 can include or be communicatively coupled to a display, such as a monitor or screen. Zone device 514 can include one or more component or functionality of client device 448. A zone device 514 can refer to or include a device located in a zone or section of a building, such as an access control device, access control panel, tablet computing device or other computing device. The zone device 514 can be a common device used by multiple users that access the zone, whereas a user device 502 can be used mostly by a user, such as an employee or tenant of the building.

As shown, controller 506 may be configured to send and receive data from building subsystems 428, which may include electrical subsystem 434, information communication technology (ICT) subsystem 436, security subsystem 438, HVAC subsystem 440, lighting subsystem 442, lift/escalators subsystem 432, and fire safety subsystem 430.

In some embodiments, a user may interact with the system 500 via user device 502. In some embodiments, a user can communicate with the scheduling system 512 using the user device 502. In some situations, the communications between the user device 502 and controller 506 can include or correspond to receiving data visually or via audio, or may correspond to changing or determining an operating parameter. The operating parameter may relate to one or multiple of building subsystems 428 (e.g., a temperature setpoint within HVAC subsystem 440, a light brightness within lighting subsystem 442, etc.).

In some embodiments, a user may request, via user device 502, to view building information. User device 502 may communicate the request to controller 506, via network 504. Controller 506 may then communicate with web server 506. Web server 506 may be configured parse or process the input. In some embodiments, for example, the format may include intent and entity parameters, and/or may be expressed in JavaScript Object Notation (JSON) format or other formats. Controller 506 may receive the data from web server 506, and determine how to proceed.

The controller 506 may perform a plurality of web page navigations prior to displaying a web page that corresponds with a user's request. Controller 506 may communicate with internal or external databases, servers, and/or building subsystems 428 to determine requested information, prior to outputting audio that corresponds with a user's request for an audio output.

In some embodiments, controller 506 may communicate with building subsystems 428 to determine a current building operating parameter, prior to changing the building operating parameter that corresponds with a user's request for change. In some embodiments, controller 506 may determine operating limits corresponding to the device specified within the user's request, prior to changing an operating parameter. Further, controller 506 may not change the operating parameter if the operating parameter would cause the equipment to exceed its corresponding operating limits.

If controller 506 determines that a visual output is needed, it may display or provide for rendering the corresponding web page on a user interface of user device 502. If controller 506 determines that an operating parameter update is needed, it may update the operating parameter, which may cause a physical change within one or more of building subsystems 428.

The controller 506 can include a zone management module 532. The zone management module 532 may include one or more layers, such as a user interface (“UI”) layer, graphical user interface layer (“GUI”), and a model layer. The one or more layers may communicate with one another. The zone management module 532 may be in communication with user device 502 (e.g., network 502). The zone management module 532 may be in communication with web server 530. The zone management module 532 may be in communication with scheduling system 512. The zone management module 532 may be in communication with building subsystems 428.

The controller 506 may access, communicate with, interface with or other use a first database 516. The first database 516 may be an external component that maintains communication with the controller 506 (or one or more component or module thereof). In some embodiments, first database 516 may correspond to a building management system (e.g., the BMS described with respect to FIGS. 1-4). Accordingly, first database 516 may store information corresponding to the building management system and the associated building subsystems (e.g., building subsystems 428). In some embodiments, the database may be updated to include current operating parameters of equipment. The database may include hardware or software components, such as a database API, storage disks, or memory. The database may be part of included on a database server.

The database may include or store information or data, such as data structures, tables, data files, multimedia content, or other data. For example, the database 516 may include zone data 518, user data 520, policies 522 or passwords 524.

A zone may refer to or include a section in a building. A zone may be a room. The room may have a type, such as a common room, conference room, presentation room, board room, office room, laboratory room, classroom, auditorium, cafeteria, etc. The zone may be tagged with or associated with an identifier. The identifier may be a unique identifier. The zone may have an alphanumeric identifier. The zone may have a location. In some embodiments, the identifier may indicate the location of the zone. The zone may have a location identifier in the building. The location identifier may be unique with respect to other location identifiers within the building.

Zone data 518 may include or refer to information about zones or section in a building being controlled or managed by the controller 506 (or BMS 366). Zone data can include, for example, room information, room availability, room location, occupancy limits, temperature setpoints, resources available in the zone, etc. User data 520 can include user preferences, such as preferred temperature setpoints, room locations, room types, resources needed, etc. Policies 522 can include rules, parameters or thresholds used by the controller 506 to perform building automation functions. For example, a policy can include a time offset as to when to adjust a temperature setpoint for a room relative to a start time of a meeting. Passwords 524 can include a unique identifier, code, key, or other password generated or selected by the controller 506 in order to control access to the zone, or resources or devices located at the zone.

The system 500 can include, interface with or otherwise communicate with building subsystems 428. The building subsystems 428 can include one or more component or functionality depicted in building subsystems 428 in FIG. 4, including, for example, fire safety system 430, lift/escalators system 432, electrical system 434, ICT system 436, security system 438, HVAC system 440, or lighting system 442. The building subsystems 428 may also include, interface with or otherwise communicate with an enterprise resource planning (“ERP”) system 508 and a cafeteria management system (“CMS”) 510. The ERP system 508 can refer to or include a system that provides management of transactions in an organization or building to facilitate error-free transactions and productions, thereby enhancing efficiency. The ERP system 508 can refer to an integrated system that integrates one or more other systems, such as a human resource system that maintains an employee database, customer services system, sales system, procurement system, production system, or distribution system. The ERP system 508 can operate in or near real time.

The CMS system 510 can facilitate ordering food or beverages to be delivered or provided in the zone during the requested time. The CMS system 510 can interface or otherwise communicate with the controller 506 to receive data regarding the request to book a zone in the building. The CMS system 510 can provide, to the controller 506, web server 530 or user device 502, information regarding menu items or other information that can be selected by a user of user device 502 for delivery in the zone. The CMS system 510 can generate a tracking identifier corresponding to the order (e.g., a data structure or data file storing identifiers for the requested menu items). The CMS system 510 can further provide status updates regarding the order, such as whether the order has been approved, submitted, in preparation, in delivery, or delivered.

In some embodiments, the controller 506 can receive a request from the user device 502. The controller 506 can receive the request via network 504. The controller 506 can receive the request via web server 530. The request can include a request to control a zone in a building. For example, the request can be to book a conference room in the building. The request can include additional information used to control the zone in the building, or the controller 506 can generate additional queries or input prompts in order to obtain the additional information to control the zone in the building. For example, the request can include or be associated with a data structure that includes one or more of a date field, a time field, a location field, a zone type field, and a resource field. The date field in the data structure can be configured to receive a date value that indicates the day for which the user desires to book the zone, such as a MM-DD-YYYY (month, day, year), today, tomorrow, etc. The time field in the data structure can be configured to receive a time value that indicates the time for which the user desires to book the zone. The time value can indicate the start time and end time for the booking. The time value can indicate the start time and a duration of the meeting. The time value can include or indicate a range of potential start times and a duration of the meeting. The time value can indicate to select a next available time (e.g., soonest next available time, or first available time on a date).

The location field in the data structure can be configured to receive a value that indicates a desired location for the booking. The location can be a building identifier if there are multiple available building, a floor identifier if there are multiple floors, a range of zones, a section in the building, a location in a campus having multiple buildings, etc.

The zone type field in the data structure can be configured to receive a value that indicates a type of zone. The type of zone can refer to or include a type of room or characteristic of the room. The type can include, for example, conference room, meeting room, large room, medium size room, small room, occupancy limit, presentation room, lab room, auditorium, cafeteria room, etc. The room type can be customized by an administrator of the system for the building. The resource field of the data structure can be configured to receive a value indicative of the type of resource the user wants to have present in the zone. Types of resources can include, for example, a projector, monitor, television, large display, a computing device, laptop computer, desktop computer, tablet computer, touchscreen interface, electronic white board, a telecommunications device, telephone, conference phone, speaker phone, microphones, a printer, scanner, etc.

Values for the fields can be input via an interface of the user device 502. Values for the fields can be selected or provided via a drop-down menu, button, input text box, or other graphical user interface widget of the user device 502. In some embodiments, values for one or more fields may be optional. For example, it may be optional to provide a value for the resource field or time field.

The controller 506, upon receiving the request, can identify available zones in the building. The controller 506 can communicate with the BMS 336 or building subsystems 428 to identify zones that satisfy the request or data fields associated with the request. The controller 506 may perform a lookup in the zone data structure 518 in database 516 using values associated with the data structure fields receive with or corresponding to the request. The controller 506 can identify, responsive to the lookup with the values, available zones or rooms. The controller 506 can provide, for display on the user device 502, the list of available zones to allow a user to select the desired zone for the meeting or other event. For example, if there is more than one available zone that satisfies the parameters or values of the request, the controller 506 can determine to provide the available zones to the user device 502. The controller 506 can provide the available zone information to the user device 502 via zone management module 532 or web server 530. The list of available zones can be provided as an interactive list. For example, selecting an available zone can cause a display of additional information about the zone or add the zone to the meeting.

The controller 506 can identify the plurality of available zones based on the resource field. The controller 506 can identify the plurality of available zones that satisfy the resource field. For example, the controller 506 can identify zones that contain or have access to the requested resource (e.g., a projector). The controller 506 can identify zones that contain the requested resource and that are available during the requested time.

The controller 506 can identify the zones based on an occupancy indication. The controller 506 can interface with or otherwise communicate with a scheduling system 512. The scheduling system 512 can be provided by a third-party. The scheduling system 512 can be a third-party system that is administered by an entity different from the entity that administers the BMS. The scheduling system 512 can include or provide an electronic calendar application. The scheduling system 512 can be linked with an electronic mail system. The scheduling system 512 can include or execute on a server. The scheduling system 512 can have store calendar entries 528 in a second database 526. The controller 506, via web server 530 for example, can access the scheduling system 512. The user device 502 can access the scheduling system 512. The user device 512 can view, create, modify or other manipulate calendar entries 528 for the user of the user device 502.

In some embodiments, the calendar entries 528 can indicate occupancy information. For example, the user device 502 can utilize the scheduling system 512 to setup a calendar entry for a meeting for a specific date and time. The user device 502 can also invite people to the meeting using the scheduling system 512 by adding the identifiers (e.g., electronic mail addresses) of the people to the calendar entry. The scheduling system 512 can determine the occupancy level for the meeting based on the number of people the user invites based on the calendar entry.

In some embodiments, the scheduling system 512 can automatically transmit an electronic notification or prompt to the corresponding identifiers using an electronic mail system linked with the scheduling system 512. The scheduling system 512 can receive responses to the calendar notifications. The responses can include an indication that the invitee will attend the meeting, will not attend the meeting, or is tentative. The scheduling system 512 can determine, based on the number of responses received that indicate the person will attend the meeting, the estimated occupancy level for the meeting. The controller 506 can receive the estimated occupancy level for the meeting from the scheduling system 512.

Thus, the controller 506 can receive an occupancy indication for the request based on a calendar entry stored in a scheduling system 512 separate from the building management system, or based on the number of affirmative and tentative responses to the calendar entry. The controller 506 can then identify the plurality of available zones that satisfy the occupancy indication. The controller 506 can access zone data 518 which can indicate the a predetermined occupancy limit for each of a plurality of zones in the building, and then select the zones that have an occupancy that is greater than or equal to the occupancy indication.

The controller 506 can receive a selection to control a first zone from the plurality of available zones. The controller 506 can receive a selection of one of the zones provided for display on the user device 502. The controller 506 can receive the selection from user device 502 via network 504.

In response to the selection, the controller 506 can generate a password to restrict control of at least one device in the first zone. The controller 506 can communicate with the security system 438 to generate the password and enable access restrictions on the devices. For example, 506 the controller 506 can transmit a request, instruction or command to the security system 438. The request, instruction or command can be to generate a password. The password can be valid for a duration that corresponds to the booking of the zone, such as a time interval corresponding to the value in the time field of the data structure associated with the request.

The security system 438, controller 506 or other building subsystem 428 can lock a door used to access the zone for the time interval. The security system 438, controller 506 or other building subsystem 428 can lock the devices in the zone for the time interval. Locking devices in the zone can refer to or include locking one or more zone devices 514. Locking devices in the zone can refer to or include temporarily disabling the device. Locking devices in the zone can refer to or include disable one or more functions or features of the device. For example, locking a telecommunications device in a zone can disable incoming calls or outgoing calls. Locking the telecommunications device in the zone can disable only certain outgoing calls, such as long distance calls, while allowing white listed or preapproved calls such as emergency outgoing calls (e.g., allowing 911 calls).

The zone device 514 can include or control devices in the zone, such as a projector, a motorized projector screen, monitor, television, large display, a computing device, laptop computer, desktop computer, tablet computer, touchscreen interface, electronic white board, a telecommunications device, telephone, conference phone, speaker phone, microphones, a printer, scanner, lighting device, temperature controller, HVAC controls for the zone. A zone device 514 can enable or unlock the other devices located in the zone.

The controller 506 can transmit the password generated for the requested zone to the user device 502. The controller 506 can store the password in a password data file or index 524 in the database 516. When the zone becomes available to the user, the controller 506 can lock the zone device 514 (or other devices located in the zone). The controller 506 can lock access to the zone (e.g., lock a door). The controller 506 can set the password as the generated password for the user.

In some embodiments, the controller 506 can limit access to the zone to those that have been invited to the meeting. The controller 506 can interface with or otherwise communicate with the scheduling system 512 to determine a list of identifiers corresponding to people who were invited, via a calendar entry or otherwise, to the meeting. In some embodiments, the controller 506 can receive the list of identifiers from the user device. The list of identifiers corresponds to those people that are authorized to access the first zone during a time interval based on the date field and the time field provided in the at least one data structure. The controller 506 can further determine a code corresponding to a security badge or other security key corresponding to the authorized people. The controller 506 can then authorize or grant access to only the authorized people. For example, the controller 506 can receive, from an access control panel at the first zone, an identifier responsive to a badge swipe at the access control panel during the time interval. The controller 506 can determine the identifier matches the list of identifiers of authorized users, and unlock, responsive to the determination, a remotely controlled lock to allow the user access to the first zone.

When the user enters or approaches the zone during the predetermined time interval, the user can input the password. The user can input the password in the zone device 514 (e.g., a tablet computing device). The user can input the password in an access control panel at or proximate to the zone. The user can input the password using a keypad, keyboard, mouse, touchscreen, finger gestures or other input mechanism.

The user can swipe a badge at the access control panel in addition to or instead of entering the password. In some embodiments, the controller 106 can unlock the zone or the devices at the zone responsive to a security key, electronic token, or biometric signature. For example, the password can include or refer to a security key, electronic token, or biometric signature. The user can input or provide the security key, electronic token, or biometric signature to the zone device 514. The user can input or provide the security key, electronic token, or biometric signature to the zone device 514 via the user device 502. For example, the controller 506 can provide the security key or electronic token to the user device 502, or an application executing on the user device 502. The user device 502 can transmit the electronic token or security key to the zone device 514 using a wireless transmission protocol. The wireless transmission protocol can include, for example, a short range communication protocol such as Bluetooth or near field communication protocol, Wifi, radio frequency identifier (RFID), etc. In some embodiments, the electronic key or security token can be transferred from the user device 502 to the zone device 514 when the user device 502 is brought into close proximity (e.g., less than 5 inches) to the zone device 514.

The controller 506 can receive, via the input interface of the zone device different from the user device, the password. The controller 506 can authorize the zone or one or more zone devices 514 for use during the requested time responsive to receiving the password (or electronic key, security token, or biometric signature). The controller 506 can compare the password, electronic key, security token or biometric signature with a stored value (e.g., stored password 524) to determine a match. The controller 506 can authorize access to the zone or authorize control of at least one device in the zone responsive to the match.

The controller 506 can set an expiration for the password. The controller 506 can generate a time interval based on a start time and an end time indicated by the time field of the at least one data structure of the request. The start time can be indicated by a value in the time field, and the end time can be indicated by the value in the time field. The end time can be indicated by a duration value in the time field. The time interval can be from the start time to the end time. The time interval can be from a predetermined amount of time (e.g., 1 minute, 2 minutes, 3 minutes, 5 minutes, etc.) before the start time to the end time. The predetermined amount of time can be determined based on whether the zone is booked by another user before the start time. For example, if the zone is booked by another user, then the time interval can begin at the start time. If the zone is not booked by another user, then the time interval can begin at the predetermined amount of time before the start time.

The controller 506 can set the password to be valid during the time interval, and expire after the time interval. The controller 506 can authorize control of the at least one device responsive to receipt of the password via the input interface of the zone device at a time within the time interval. The controller 506 can prevent control of the at least one device responsive to receipt of the password via the input interface of the zone device 514 at a time outside the time interval. For example, if the password is received after the password has expired, then the user will be prevented from accessing the zone or controlling the device at the zone.

In some embodiments, the controller can apply or use policies to control devices in the zone. The controller 506 can retrieve a policy to control a device. The controller 506 can retrieve the policy from the policy database 522. The policy can be established or configured for the building, the zone, the user, or the specific booking of the zone. The policy can be adjusted by the user during booking of the zone, or prior to accessing the zone, or while using the zone. The controller 506 can retrieve the policy using a lookup or otherwise querying the policy database 522.

The controller 506 can execute, run, apply or otherwise perform the actions or controls specified by the policy. The controller 506 can execute the policy at a predetermined time interval prior to a start time indicated in the time field of the at least one data structure of the request. The predetermined time interval can be, for example, 1 minute, 2 minutes, 3 minutes, 4 minutes, 5 minutes or more. For example, the policy can indicate a temperate setpoint for the zone. The policy can indicate to adjust the temperature setpoint two minutes before the start time of the room. The new setpoint can be indicated by the user. The new setpoint can be a default setpoint to use for the zone when the zone is occupied. The setpoint can be a default setpoint for the season. The setpoint can correspond to a preference of the user requesting the zone, as indicated in the user data 520. Thus, the controller 506 can generate a command to adjust a temperature set point for the first zone at a predetermined time interval prior to a start time indicated in the time field of the at least one data structure of the request.

In some embodiments, the policy can be based on an occupancy level. The controller 506 can communicate with a building subsystem 428 to determine or detect the occupancy in the zone. The controller 506 can communicate with the security system 438 to determine the occupancy level. The occupancy level can indicate a number of people in the zone. The occupancy level can indicate a degree, such as low, medium, or high. The occupancy level can indicate whether the zone is below capacity, at capacity or above capacity. The occupancy level can indicate a percentage capacity, such as 25%, 50% capacity, 75% capacity, or 100% capacity.

The controller 506 can execute the policy to control, override or otherwise adjust a device in the zone responsive to or based on the capacity level. For example, the controller 506 can execute the policy to override a temperature set point responsive to the occupancy level exceeding a threshold established in a database for the first zone. The threshold can be set in the policy data base 522. For example, the temperature set point can be 72 degrees Fahrenheit. If the occupancy level exceeds 75%, the policy can indicate to lower the set point to 70 degrees due to increased number of people.

The controller 506 can identify and execute one or more policies based on occupancy detection. The controller 506 can identify and execute a policy based on detecting occupancy by a specific user in a zone. The controller 506 can identify a default policy for a zone and a user policy for a user for the zone. The controller 506 can determine whether the default policy and the user policy are compatible with one another. If the controller 506 detects a conflict or incompatibility between the default policy and the user policy, the controller 506 can use logic to determine how to override one or more parameters and combine the two policies in a compatible manner. For example, the controller 506 can determine a higher ranking or higher priority, and adjust or limit parameters in lower ranking or lower priorities to satisfy the parameters, thresholds or offsets established in the higher ranking policy.

In some embodiments, the controller 506 can detect occupancy in a first zone of a plurality of zones in a building. The controller 506 can detect occupancy based on a badge swipe at a badge reader. The controller 506 can detect occupancy based on an input or other interaction with an access control panel. The controller 506 can detect occupancy based on a proximity sensor. The controller 506 can further identify a user identifier associated with the occupant that triggered the occupancy detection. For example, the badge reader electronic transaction can indicate the user identifier.

The controller 506 can retrieve, from a database (e.g., policy database 522), a first policy established for the zone and a second policy established for the user identifier. The controller 506 can combine the first policy with the second policy to generate a merged policy. Combining the policies can refer to or include determine whether the policies are compatible with one another. If the policies are compatible (e.g., do not conflict) with one another, then the controller 506 can apply or execute both policies. Thus, the merged policy can refer to or include both policies. If, however, the controller detects an incompatibility, then the controller 506 can modify, adjust, remove or otherwise manipulate one or both of the policies to generate a merged policy or execute both policies. For example, the controller can override a parameter in the second policy, such as a temperature increase or temperature request.

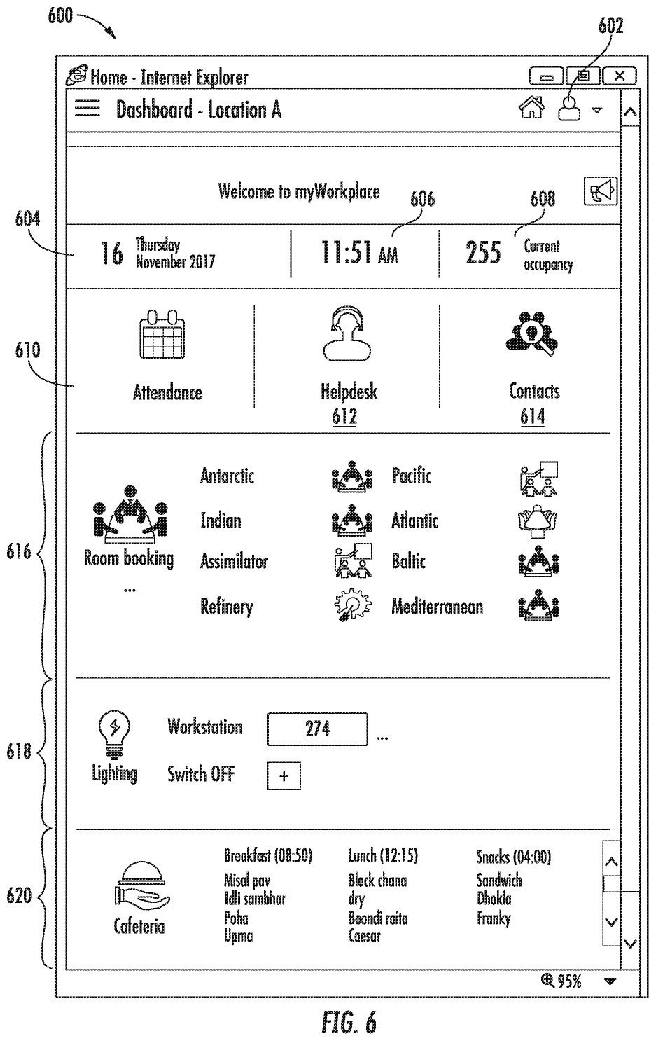

Referring now to FIG. 6, a diagram of a graphical user interfaces (“GUI”) used by the system depicted in FIG. 5, according to some embodiments, is shown. The GUI depicted in FIG. 6 can be used for meeting room booking. For example, the user can use user device 502 to search for different rooms available on the floor for booking as per his/her requirement, and check whether they are currently occupied or empty. The user can view the room availability & room bookings in calendar view for room bookings on daily/weekly/monthly basis. The user can view the different rooms on the floor layout for easy identification. The user can add a filter of room type (e.g. Meeting room, Conference room, Board room, Auditorium, etc.). The user can view rooms for different locations available on same network and book for any other location than base location. The user can filter rooms as per resources available, such as video conferencing, projector, telephone, extra chairs, etc.

The GUI 600 can be provided by one or more system or component depicted in FIG. 5, including, for example, the controller 506, scheduling system 512, web server 530, building subsystems 428, or user device 502. The GUI 600 can be used to book a zone or meeting room. The user can log in or out of the application via login button 602. The GUI 600 can indicate the date 604 of the meeting. The GUI 600 can indicate a current time 606. The GUI 600 can indicate the current occupancy 608 of one or more zones associated with Location A. For example, the current occupancy 608 can indicate the current occupancy of a specific zone or room identified as Location A. The current occupancy 608 can indicate the current occupancy of a building identified as Location A. The current occupancy 608 can indicate the current occupancy of a campus identified as Location A.

The GUI 600 can include a button to contact the helpdesk 612. The GUI 600 can provide access to the contacts stored or linked to the user device 502 via contacts button 614. The GUI 600 can list one or more zones 616. The zones 616 can be all zones at Location A. The zones 616 can be available zones at Location A. The GUI 600 can include identifiers for each of the zones 616, as well as an indication of the type of resource available at each of the zones (e.g., an icon indicating a type of resource or type of room). The GUI 600 can include device controls 618 for devices located or associated with the zones. The device controls 618 can include lighting controls or workstation controls, such as a workstation identifier.

The GUI 600 can include access to cafeteria order information 620. The cafeteria order information 620 can be provided by the controller 506 or web server 530 interfacing or communicating with a CMS 510.

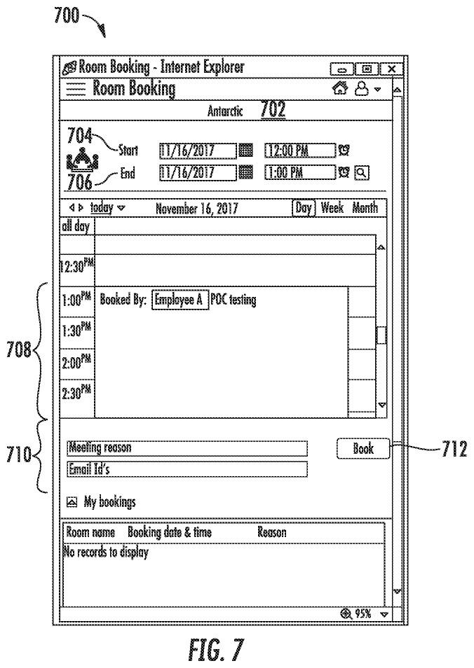

Referring now to FIG. 7, a diagram of a graphical user interface of a room booking view provided by the system depicted in FIG. 5, according to some embodiments, is shown. The GUI 700 can be provided by one or more system or component depicted in FIG. 5, including, for example, the controller 506, scheduling system 512, web server 530, building subsystems 428, or user device 502. The GUI 700 can be used to book a zone or meeting room. The GUI 700 can indicate an identifier 702 of the zone. The GUI 700 can provide an input text box or other input widgets for the start 704 and end 706 of the meeting. The GUI 700 can indicate, in a calendar view 708, the booking of the zone or room. The GUI 700 can indicate a meeting reason and email identifiers 710 of people to be invited to the meeting. The GUI 700 can include a book button 712 that sets the reservation for the room.

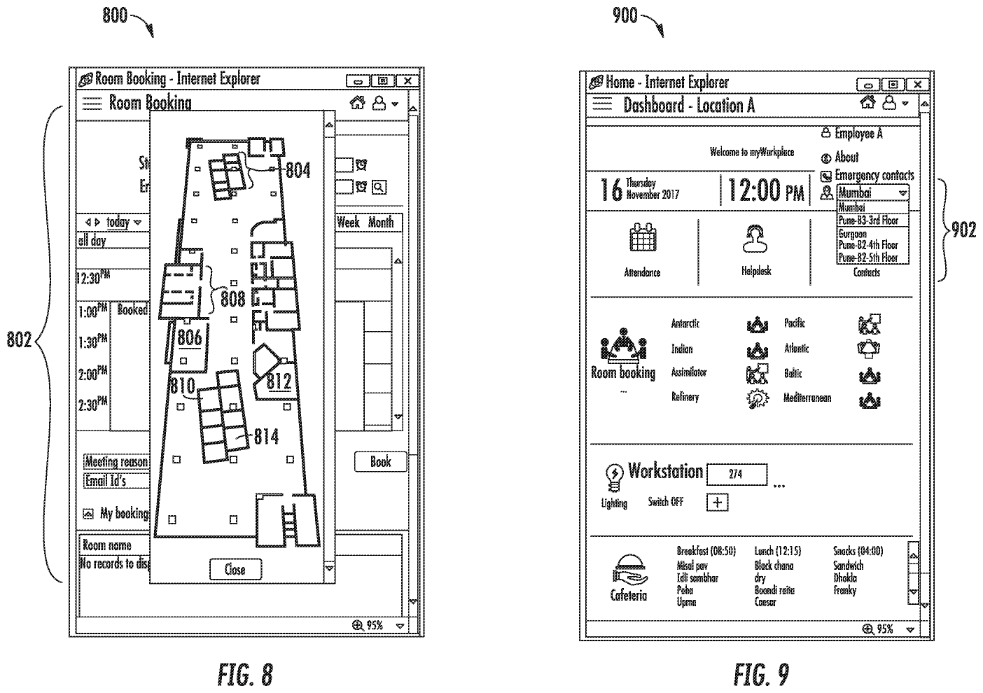

Referring now to FIG. 8, a diagram of a graphical user interface for zone selection provided by the system depicted in FIG. 5, according to some embodiments, is shown. The GUI 800 can be provided by one or more system or component depicted in FIG. 5, including, for example, the controller 506, scheduling system 512, web server 530, building subsystems 428, or user device 502. The GUI 800 includes an illustration or map 802 of zones at the location A. The map 802 can indicate one or more zones, such as zones 804, 806, 808, 810, 812 and 814. The map 802 can be for a specific location A, a floor at location A, or a section at location A. The map 802 can be a dynamic or interactive map. The map 802 can further indicate which zones are available based on the criteria or parameters associated with the booking request. For example, the map 802 can indicate that zones 812, 814 and 806 are available (e.g., by a highlight feature, icon, different color, symbol, or other indicator). The map 802 may further indicate which zones are not available for booking, either due to the time request or the resource available request, or for some other reason. Thus, the controller 506 can indicate, via GUI 800 and map 802, which zones are available for booking. The map can be retrieved from a zone data database 518.

Referring now to FIG. 9, a diagram of a graphical user interface for location selection provided by the system depicted in FIG. 5, according to some embodiments, is shown. The GUI 900 can be provided by one or more system or component depicted in FIG. 5, including, for example, the controller 506, scheduling system 512, web server 530, building subsystems 428, or user device 502. The GUI 900 provides a drop down menu 902 to allow the user to select, via user device 502, the location at which to book the room.

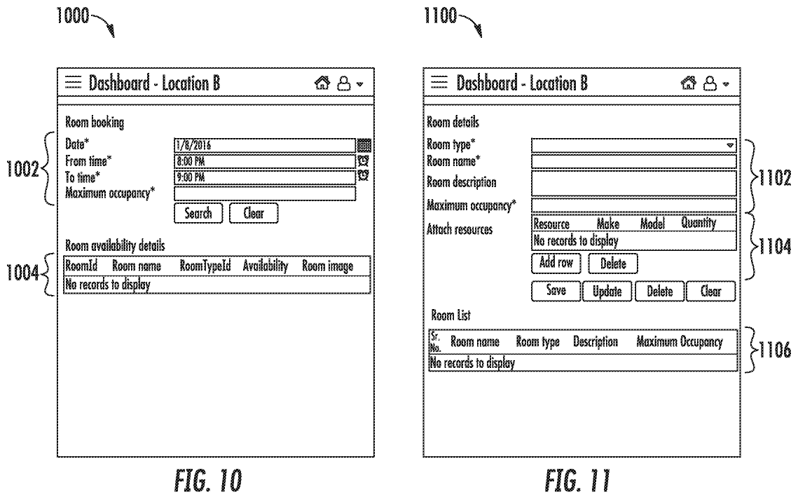

Referring now to FIG. 10, a diagram of a graphical user interface for room booking provided by the system depicted in FIG. 5, according to some embodiments, is shown. The GUI 1000 can be provided by one or more system or component depicted in FIG. 5, including, for example, the controller 506, scheduling system 512, web server 530, building subsystems 428, or user device 502. The GUI 1000 provides a room boking input 1002, where a user, via user device 502, can input the date, start time or from time, end time or to time, and maximum occupancy. Upon inputting the rooming information 1002, the user can initiate a search for available rooms (or zones). The results of the search can be displayed in search results 1004.

FIG. 11 is a diagram of a graphical user interface for resource booking provided by the system depicted in FIG. 5, according to some embodiments. The GUI 1100 can be provided by one or more system or component depicted in FIG. 5, including, for example, the controller 506, scheduling system 512, web server 530, building subsystems 428, or user device 502. The GUI 1100 includes input box 1102 where a user can input values for resource fields or specify room type. For example, the user can input a room type, room name, room description, maximum occupancy, and requested resources 1104. The search results can be displayed at 1106.

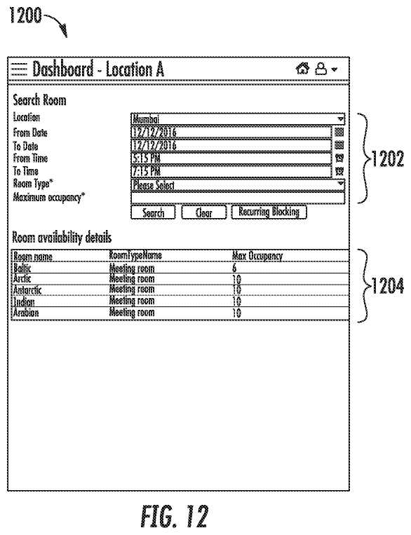

FIG. 12 is a diagram of a graphical user interface for search results used for room and resource booking provided by the system depicted in FIG. 5, according to some embodiments. The GUI 1200 can be provided by one or more system or component depicted in FIG. 5, including, for example, the controller 506, scheduling system 512, web server 530, building subsystems 428, or user device 502. The GUI 1200 illustrates search results based on input received in via GUIs 1000 and 1100. With the search inputs 1202, the controller 506 or system 500 can perform a search, query or lookup in database 516 (or zone data 518) to identify available rooms, and list the search results in block 1204.

Thus, GUIs 1000, 1100 and 1200 provided by system 500 allow a user to select rooms based on occupancy capacity, thereby allowing more efficient use of meeting rooms and avoiding single person occupying bigger rooms. The system 500 can provide recurring booking enabled for users where weekly/monthly room booking can be carried out. The system 500 provides integration with a scheduling system to allows users to carry out room booking transactions between system 500 and the scheduling system, and view information on both platforms. The system 500 can provide a room booking history page added to view status of all bookings across all rooms.

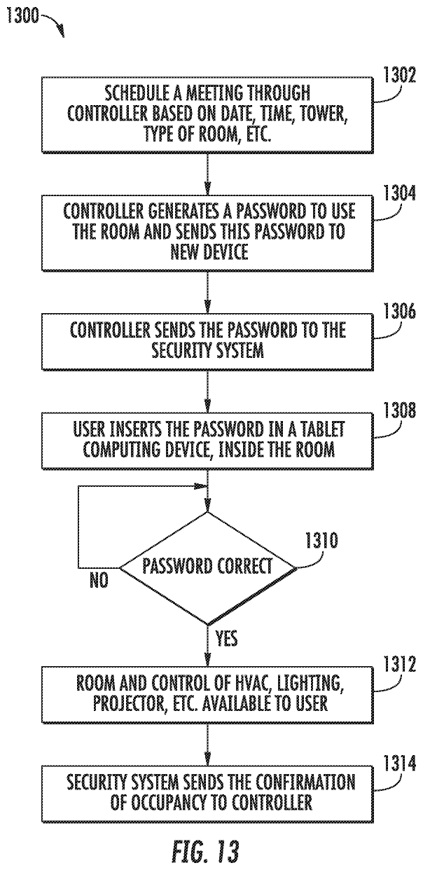

FIG. 13 is a flowchart of a process for access control, according to some embodiments. The process 1300 can be performed by one or more system or component depicted in FIG. 5, including, for example, the controller 506, scheduling system 512, web server 530, building subsystems 428, or user device 502. The process 1300 can include applying a rule or policy to tag meeting rooms like video conferencing rooms or board rooms as access restricted rooms and allow controlled access based on access control system (e.g., security system 438). For example, if an employee wants to book special room, then a request may be sent to an approver, and once approved, then a confirmation may sent to the user booking the room that grants access to the room as per the timings chosen by user. Password generation along with room booking can be done as part of which user receives a notification with a one-time password (“OTP”) which may be used for authentication and for access to a meeting room (or zone) along with communication to BMS for lighting & HVAC control. An OTP is a type of password that is valid for only one use (or a predetermined number of uses). The OTP can be a secure way to provide access or perform a transaction only one time (or a predetermined number of times). The password can become invalid after it has been used, and may not be used again. The OTP can be generated using a short time expiration, or function using random numbers. The OTP generator can use random characters and symbols to create a password.

At 1302, a meeting can be scheduled through a controller 506. The meeting can be scheduled based on a date, time, tower (e.g., location), type of room, or other parameters or fields. At 1304, the controller 506 can generate a password to use the room, and send this password to the user device 502. At 1306, the BMS controller can send the password to the security subsystem 438. At ACT 1308, the user can insert the password in a tablet (e.g., zone device 514) located in the zoon. At decision block 1310, the system can determine whether the password input by the user is correct. If the password is not correct (e.g., does not match the password created at 1304), the process reverts back to 1308, where the user or another user may enter a password again. If the password is correct and matches the password created at 1304, as determined at decision block 1310, then the process proceeds to 1312. At 1312, the room and control of HVAC, lighting, projector, or other devices are authorized and become available to the user to control and use. At 1314, the security subsystem 438 can provide a confirmation of occupancy to the controller 506.

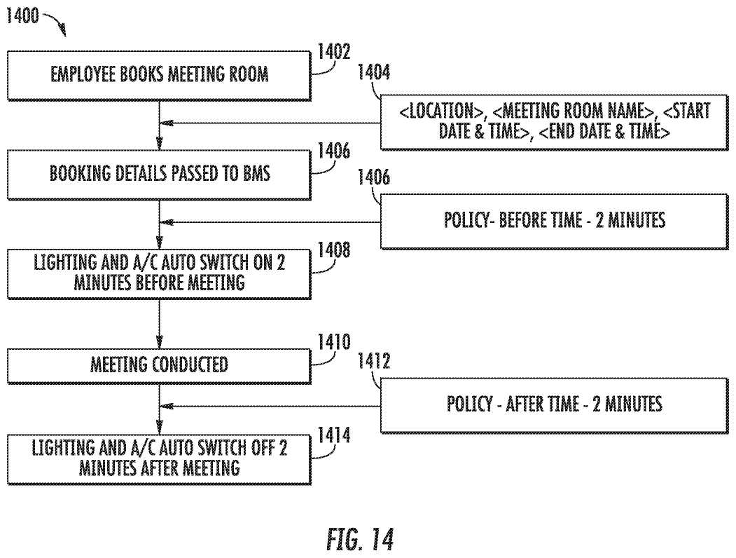

Referring now to FIG. 14, a flowchart of a process for comfort management, according to some embodiments, is shown. The process 1400 can be performed by one or more system or component depicted in FIG. 5, including, for example, the controller 506, scheduling system 512, web server 530, building subsystems 428, or user device 502. At ACT 1402, when user books a meeting room, the information 1404 can be captured. The information 1404 can include, for example, space details—<Location> <Meeting Room Name>; duration of room booking—<Start Date & Time> <End Date & Time>. The information 1404 can be captured as values in one or more fields of a data structure. The information 1404 can be captured as a string, characters, symbols, alphanumeric values, etc. At ACT 1406, the booking details can be passed to a BMS controller (e.g., controller 506). The command can be carried out using a higher priority allocation <Operator Over ride>.

At 1406, the system 500 can provide policy or rule to define a configurable time in minutes before and after the meeting to be used to switch ON/OFF lighting and air-conditioning (or other devices) of the meeting room. For example, the duration of time before and after the meeting can be 2 minutes, 3 minutes, 4 minutes, 5 minutes or more. At ACT 1408, and based on the details passed and the policy, the controller 506 can perform the following actions: lighting and air-conditioning points are automatically switched ON 2 minutes before the meeting starts. At 1410, the meeting can be conducted. At 1414, and responsive to the policy or rule 1412, lighting and air-conditioning points are automatically switched OFF 2 minutes after the meeting ends.

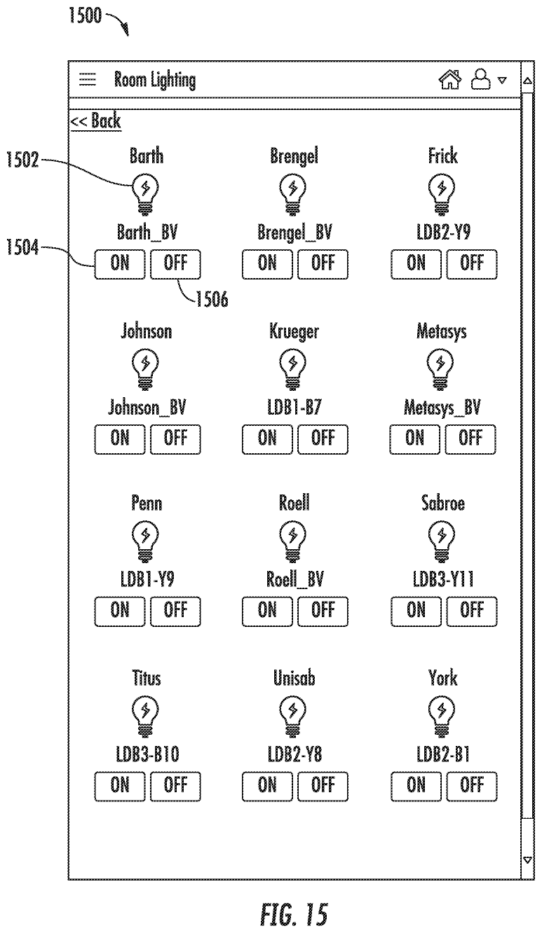

Referring now to FIG. 15, a diagram of a graphical user interface for room lighting provided by the system depicted in FIG. 5, according to some embodiments, is shown. The GUI 1500 can be provided by one or more system or component depicted in FIG. 5, including, for example, the controller 506, scheduling system 512, web server 530, building subsystems 428, or user device 502. The GUI 1500 illustrates a plurality of lighting devices, such as a lighting device 1502. The GUI 1500 provides an ON button 1504 and an OFF button 1506 to control the lighting device 1502. Selecting the ON button or OFF button 1506 can turn on or off the lighting device 1502. The GUI 1500 can be provided for display via a user device 502 or zone device 514 responsive to the user being granted access and authorization to the zone.

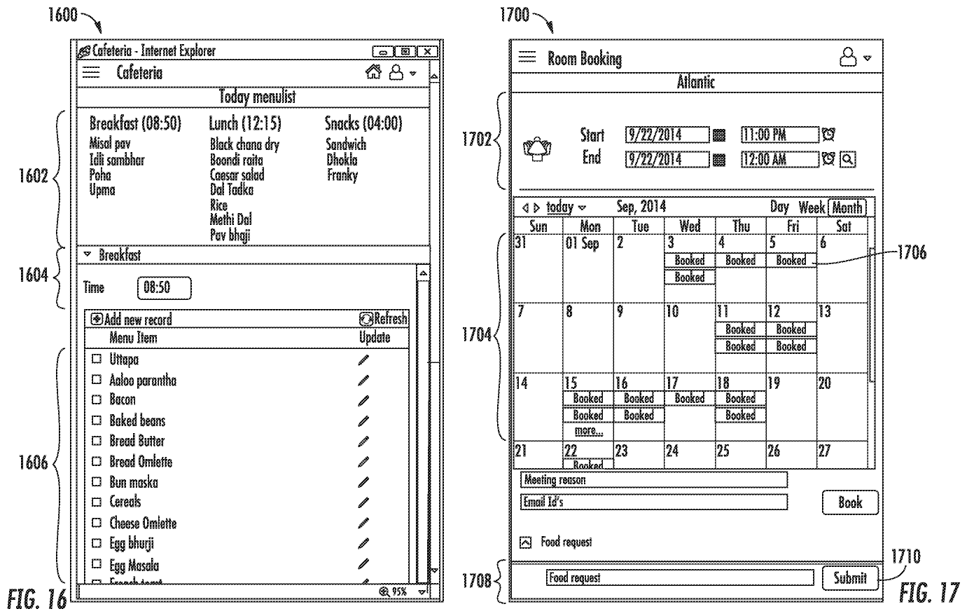

Referring now to FIG. 16, a diagram of a graphical user interface for cafeteria requests by the system depicted in FIG. 5, according to some embodiments, is shown. The GUI 1600 can be provided by one or more system or component depicted in FIG. 5, including, for example, the controller 506, scheduling system 512, web server 530, building subsystems 428, or user device 502. The GUI 1600 allow the user to make cafeteria requests. The GUI 1600 allows the user to submit food requests along with the room booking by selecting from existing cafeteria menu or by allowing user to enter their own request. Once submitted, the food request transmitted to the cafeteria management system 510 through an electronic notification (e.g., e-mail request) along with a tracking ID.

The GUI 1600 includes a menu list 1602 that indicates the menu items selected or available for selection for Breakfast, Lunch and Snacks. The GUI 1600 provides a breakfast time input box 1604, where a user can input the start time of breakfast for their meeting. The GUI 1600 provides a menu of items 1606 that can be selected from. The user, via user device 502, can select one or more items in menu input box 1606. Upon selecting menu items, the system 500 can add the selected menu item for breakfast (as selected in 1604), and update the display 1602 to illustrate the current menu selections.

Referring now to FIG. 17, a diagram of a graphical user interface for room booking with cafeteria requests by the system depicted in FIG. 5, according to some embodiments, is shown. The GUI 1600 can be provided by one or more system or component depicted in FIG. 5, including, for example, the controller 506, scheduling system 512, web server 530, building subsystems 428, or user device 502. GUI 1700 illustrates a start time and end time for the zone in box 1702. The GUI 1700 provides a calendar view 1704, which can show the days that the zone is booked (e.g., 1706). The GUI 1700 can further show the food request 1708, and allow the user to submit the food request (e.g., as established via GUI 1600) via submit button 1710.

Thus, systems and methods of the present disclosure allow users to make use of common areas like meeting rooms or zones, and book for their own requirements along with flexibility to book room resources and food requests as desired. Through the integration of the zone management module 532 with BMS and application of specific policies, the comfort conditions for meeting rooms are maintained automatically, thereby allowing energy efficient usage and better resource management. Specific conditions for accessing the meeting rooms like password generation/access control through reader interlocked with meeting room timings allows for better control of accessing meeting rooms. The zone management module 532 allows the user to manage features of the present disclosure through one unified interface, thus simplifying the process for users thus making it efficient and saving time. The zone management module 532 may have tightly coupled integration with BMS, Access Control systems or other building subsystems 428 which facilitates efficient room booking processes with resources desired by users without any dependency on facility managers for allowing controlled changes to work environment.

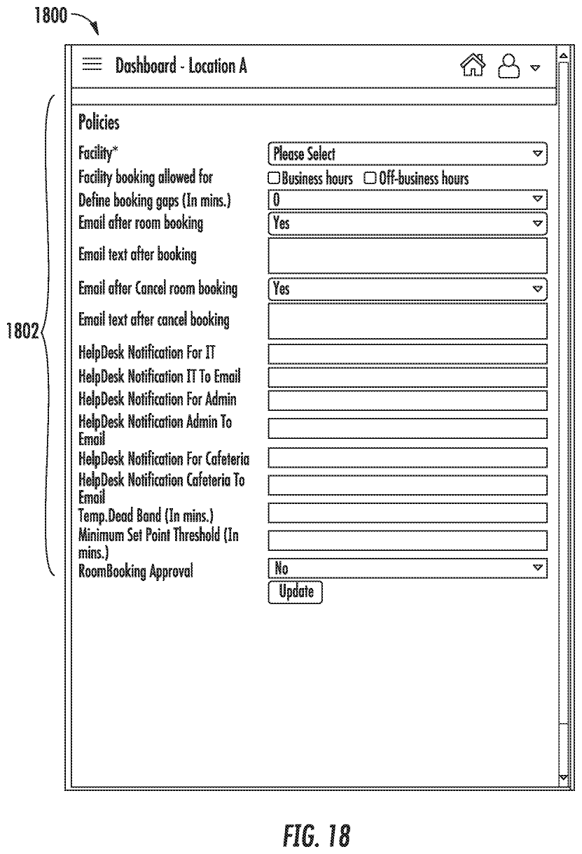

Referring now to FIG. 18, a diagram of a graphical user interface for inputting policies to be executed by the system depicted in FIG. 5, according to some embodiments, is shown. The GUI 1800 can be provided by one or more system or component depicted in FIG. 5, including, for example, the controller 506, scheduling system 512, web server 530, building subsystems 428, or user device 502. The zone management module 532 can be configured to receive customized policies and execute the policies. The zone management module 532 allows an administrator to dynamically configure the application and system as per customer specifications. For example, instead of defining hard coded logic and algorithms, the zone management module 532 can allows for the creation of policies towards meeting the custom requirements around workplace comfort management and access control.

GUI 1800 can provide, as part of the application configuration, the user assigned as administrator the provision to define specific policies for the implementation. The user can define specific policies (or rules) for different locations defined in the space hierarchy using the policy input interface 1802. The policy input interface 1802 can provide a drop down menu to allow the user to select the facility. The policy input interface 1802 can provide a hierarchy for the room booking feature that includes, among other things: i) selection for allowing room booking during business hours/off business hours; ii) define gap in minutes for allowing subsequent room bookings: iii) allow sending mail notifications after successful room booking; iv) define content of the mail notifications after successful room booking; v) allow notification after cancellation of room booking; vi) define content of the mail notifications for cancellation of room booking; vii) approval for room booking.

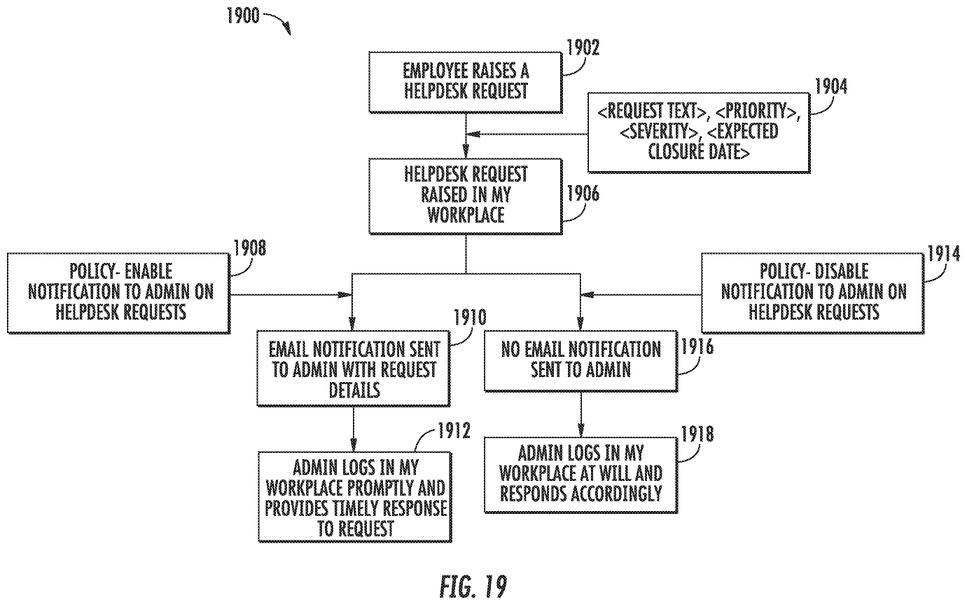

Referring now to FIG. 19, a flowchart of a process for inputting policies to be executed by the system depicted in FIG. 5, according to some embodiments, is shown. The process 1900 can be performed by one or more system or component depicted in FIG. 5, including, for example, the controller 506, scheduling system 512, web server 530, building subsystems 428, or user device 502. The zone management module 532 can be configured to allow the user to define specific rules (or policies) for different locations defined in the space hierarchy. For example, the helpdesk feature can be configured with policies such as: i) enable/disable notification when user raises request against different request types available under Helpdesk menu; and ii) define content to be sent as part of the notification for different request types.

AT 1902, an employee can raise a helpdesk request. The request can include input 1904, such as <request text>, <priority>, <severity>, and <expected closure date>. At 1906, the request can be provided or transmitted or processed by the zone management module 532. At 1908, the zone management module 532 can identify a policy configured by the administrator. The policy, for example, can be to enable notifications to administrator on help requests. At 1910, the system can execute the policy identified at 1908 and e-mail a notification to the administrator with the requested details. AT 1912, the system can receive, in response to the administrator receiving the notification, a login by the administrator in order to respond to the request.

If, for example, the policy identified is to disable notifications to the administrator on help requests, as identified at 1914, the system can prevent, block, or otherwise not send a notification of the request to the administrator at 1916. At 1918, the administrator can login to the system and respond to the request unprompted by the system.

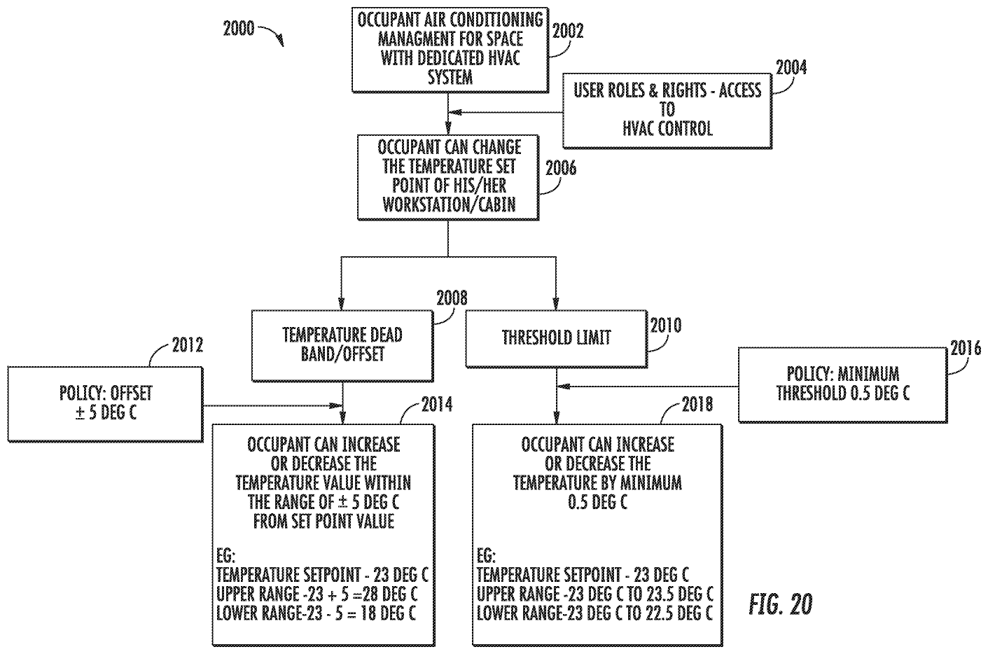

Referring now to FIG. 20, a flowchart of a process for inputting temperature control policies to be executed by the system depicted in FIG. 5, according to some embodiments, is shown. The process 2000 can be performed by one or more system or component depicted in FIG. 5, including, for example, the controller 506, scheduling system 512, web server 530, building subsystems 428, or user device 502. The comfort management or temperature control policy can cause the system to sync with the temperature offset defined in the BMS system. The zone management module 532 can be configured to receive, from the user, a lower and upper limit in which the user can change the set point of the space assigned to him/her (e.g., 5 degrees). The zone management module 532 can define or receive the minimum threshold for set point correction (e.g., −0.5 deg/1 deg etc.).

At 2002, the occupant air-conditioning management for space with dedicated HVAC system process can be initiated. At 2004, the system receives user roles and rights, along with access authorization to HVAC control. At 2006, the system can receive, from the occupant, a request or indication to change the temperature set point of his or her workstation, cabin or zone. At 2008, the system can determine the temperature dead band or offset. At 2012, the system can identify a policy established for this request, such as the authorized offset amount of a plus or minus 5 degree Celsius offset amount. The system can identify the policy for the specific zone the user is occupying. For example, the system can use occupancy techniques (e.g., via security system 438) to identify the policies 522 established for the zone. This policy can be to set or limit or control the maximum amount by which the user is authorized to change the temperature. At 2014, the system can execute the change in accordance with the policy. For example, the occupant can increase or decrease the temperature value within the range of plus or minus 5 degrees from the set point value. For example, if the set point value for the zone is 23 degrees Celsius, then the upper range to which the occupant can change the temperature is 28 degrees Celsius, and the lower range to which the occupant change the temperature is 18 degrees Celsius.

If, for example, the policy established for the zone is based on a threshold limit 2010, the system can identify the policy 2016 as a minimum threshold of 0.5 degree Celsius change, for example. At 2018, the system can execute the identified policy 2016 by allow the occupant to increase or decrease the temperature by the minimum threshold of 0.5 degrees Celsius. For example, if the temperature set point is 23 degrees Celsius, then the increase can be 23.5 degrees Celsius or the decrease can be 22.5 degrees Celsius.

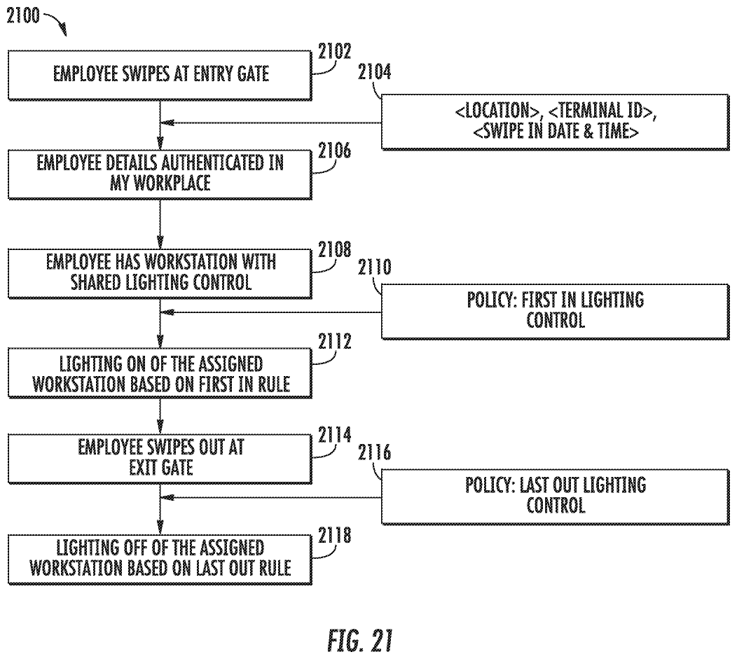

Referring now to FIG. 21, a flowchart of a process for inputting lighting control policies to be executed by the system depicted in FIG. 5, according to some embodiments, is shown. The process 2100 can be performed by one or more system or component depicted in FIG. 5, including, for example, the controller 506, scheduling system 512, web server 530, building subsystems 428, or user device 502. Based on the lighting layout distribution at a location, and its mapping in BMS in the form of soft points, the zone management module 532 can receive a policy including custom logic that allows end users to control their lighting switching ON/OFF. The zone management module 532 can allow multiple point mapping to multiple workstations, and apply logic for control. For example, if multiple lights are assigned to multiple workstation users, then the zone management module 532 can determine that the lighting is ON for the first user and the lighting is OFF when last user leaves the office.

For example, at 2102, an employee can swipe a badge at a badge reader at an entry gate. At 2104, the system identified, responsive to the badge swipe, a <location>, <terminal ID>, and <swipe in date and time>. At 2106, the employee details are authenticate by the zone management module 532 (e.g., via security system 438). At 2108, the system determine the employee's workstation is configured with shared lighting control. At 2110, the system can identify a policy established for the <location> or the employee's workstation, such as first in lighting control. The system can perform a lookup in policies database 522 using input 2104, for example, to identify the policy 2110. At 2112, the system can execute the policy to set lighting ON for the assigned workstation based on the first in policy 2110. AT 2114, the employee swipes out at an exit gate. At 2116, the system can identify a policy last out lighting control, based on a lookup using information associated with the swipe. At 2118, upon executing the identified policy at 2116, the system can turn lighting OFF for the assigned workstation based on the last out rule policy.

Thus, the zone management module 532 can be configured to allow for the provision of dynamic policies or rules to meet customer requirements, thereby allowing for customized improvements to efficiency around comfort control and building space management. The zone management module 532 allows, based on the customer profile and requirements, a definition of custom policies that allow an administrator of the tool to manipulate the capabilities around comfort control and building space management and extend it to end users/employees/tenants. For example, instead of hard coding the feature, the zone management module 532 allows each customer to set all their preferred conditions or policies during the setup and configuration in one location as one time activity which can be later managed by customer representative themselves without any dependency on service provider.

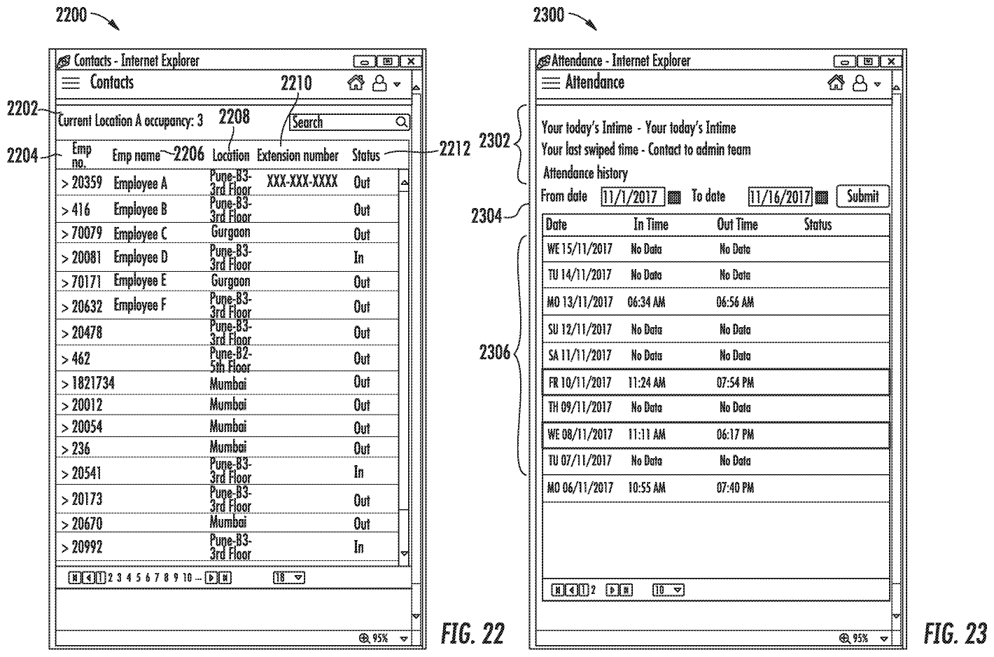

Referring now to FIG. 22, a diagram of a graphical user interface for integrating contacts for use with the system depicted in FIG. 5, according to some embodiments, is shown. The GUI 2200 can be provided by one or more system or component depicted in FIG. 5, including, for example, the controller 506, scheduling system 512, web server 530, building subsystems 428, or user device 502. The zone management module 532 can facilitate an employee connecting, communicating or collaborating with his/her colleagues, thereby improving productivity and results. The zone management module 532 allows employees to check the availability of fellow employees and provides the ability to contact them. The zone management module 532 provides the ability to check the entry and exit to office premises to track attendance and avoid maintaining registers. For example, the zone management module 532 can provide technical solutions for the following scenarios: i) employee wants to have an urgent meeting on a project delivery and wants the person sitting in the same location to come to his zone; ii) employee is trying to get in touch with a colleague and sees that the colleague is offline in a chat application and not available on phone, but how can the employee determine whether the colleague is in the office? and iii) how can an employee track entry and exit to a base location and other office locations being visited? Thus, the zone management module 532 can integrate or utilize contacts and present them for view viewed along with their availability status and also track self-attendance of different office premises.

By integrating with the security system 438, the zone management module 532 can track or monitor specific attendance and employee availability across office locations. The zone management module 532 can track or monitor multiple locations through its integration with the access control system. The zone management module 532 can track the location of employees and provide information on whether the person is IN or OUT of the office premises based on the swipe carried out by the employee. The zone management module 532 can track swipe in and swipe out details of the employee to track their availability. The zone management module 532 can provide this information via a contacts GUI 2200, along with information about employee number, employee name, location, email, contact number, workstation and status on whether the person is ‘IN’ or ‘OUT’, for example. The access control system (or security system 438 or zone management module 532), can identify, receive or determine the following data points for the employee or occupant transaction: <Location> <Terminal ID>; User details—<Badge ID> <User ID>; and Time details—<Swipe In Date & Time> <Swipe Out Date & Time>.

The zone management module 532 depicts, at 2202 via GUI 2200, the current location being viewed. The GUI 2200 can provide employee numbers 2204, employee names 2206, employee location 2208, extension number 2210, and status 2212 for each employee.

Referring now to FIG. 23, a diagram of a graphical user interface for attendance tracking generated by the system depicted in FIG. 5, according to some embodiments, is shown. The GUI 2300 can be provided by one or more system or component depicted in FIG. 5, including, for example, the controller 506, scheduling system 512, web server 530, building subsystems 428, or user device 502. The zone management module 532 can generate and display, via GUI 2300, information tracking an employee's current location, attendance, and additional details at 2302. The employee can input a start and end date via input box 2304 to track historical records of swipe information and attendance. The historical results can be displayed at 2306 and include, for example, date, in time, out time, and status. The data points used to perform the tracking can include <Location> <Terminal ID>; User details—<Badge ID> <User ID>; and Time details—<Swipe In Date & Time> <Swipe Out Date & Time>.

Thus, the zone management module 532 can allow employees to track individuals across different locations and collaborate with colleagues, track their own swipe details along with attendance for current and previous time periods, and allows users to connect with their colleagues, thereby increasing a collaborative index and team work while improving productivity.

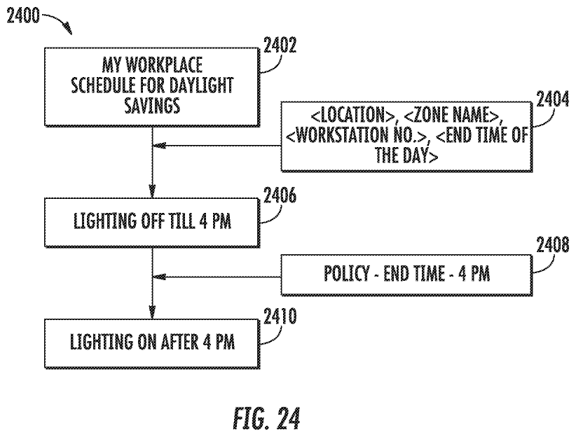

Referring now to FIG. 24, a flow chart for a process of schedule-based comfort management provided by the system depicted in FIG. 5, according to some embodiments, is shown. The process 2400 can be executed by one or more system or component depicted in FIG. 5, including, for example, the controller 506, scheduling system 512, web server 530, building subsystems 428, or user device 502. Workplace management can impact the productivity of the employees and their health. The zone management module 532 can identify issues faced by users around comfort management and provide methods to resolve it. For example, occupant/employee may face following challenges at workplace: i) glazing effect on desktop/laptop screens due to excess light due to which employee not able to focus on work; ii) darkness/dullness near workstation due to which employee has to focus more to see things thus impacting the eye sight and work; iii) employees feeling hot/cold at their workstation/cabins/meeting rooms which makes them uncomfortable to work hence impacting the health and productivity; iv) in case of any changes or modifications needed, employee has to contact Facility/Admin teams every time for a solution thus spending more time in resolution and having dependency on facility/admin teams all the time to handle their requests; v) if all meeting rooms are booked then how can employee manage to conduct meetings through his workstation.

The zone management module 532 can provide comfort management through Scheduled/On-Demand mechanisms that allow the users to manage their work environment. The zone management module 532 can provide comfort management to occupants/employees by integrating with the BMS system and access control systems (e.g., security system 438). The zone management module 532 can provide for Lighting & Air-conditioning functions and other comfort managing functions by integrating with heterogeneous or different systems. For example, the BMS—FQR (Fully Qualified Reference) Point information assigned to lighting & air-conditioning functions for available office spaces can include different data point types, such as: i) space lighting point ON/OFF Command—Binary Input; ii) Space lighting point ON/OFF Status—Binary Output; iii) Space temperature point ON/OFF Command—Binary Input; iv) Space temperature point ON/OFF Status—Binary Output; v) Space temperature sensor value—Analog Output; vi) Space temperature set point value—Analog Output; and vii) Space temperature set point correction—Analog Input.

The zone management module 532 can obtain information from or otherwise integrate with the security system 438 (e.g., access control system) to obtain employee/occupant transaction details that can include data points: i)<Location> <Terminal ID>; ii) User details—<Badge ID> <User ID>; and iii) Time details—<Swipe In Date & Time> <Swipe Out Date & Time>. This data can be collected on a real time basis towards offering comfort management using BMS & Access Control System APIs and building automation and control network (BACnet).

The zone management module 532 can provide comfort management to occupants/employees via: i) scheduled lighting & air-conditioning control; ii) schedule based space lighting control for workstations; iii) schedule based space lighting & HVAC control with Room Booking; iv) on-Demand lighting & air-conditioning control; v) on demand based space lighting control with help of Access Control system; vi) on demand based space lighting control for workstation/cabin; and vii) on demand based space air-conditioning control for workstation/cabin.

The zone management module 532 can allow provision of comfort management in a flexible and customized manner by executing policies and roles/rights offered to the different user groups. For example, policies, roles and rights can include or be based on: i) lighting management as per BMS schedule defined for the floor to achieve daylight saving; ii) lighting & air-conditioning management as per room booking start and end time; iii) lighting management for workstations with shared lighting control—First In & Last Out; and iv) lighting management for cabin lighting control in sync with access control information. The zone management module 532 can, therefore, provide energy savings through daylight savings achieved by scheduled and on demand lighting & HVAC control, while enhancing employee productivity through better comfort management.

The zone management module 532 can provide schedule based Comfort Management functions, such as schedule based space lighting control for workstations. This function can work in sync with BMS for lighting management. The zone management module 532 can provide energy savings functions by providing the capability to define a schedule for which the lighting will be kept OFF for the identified workstations (especially situated next to window for capturing daylight savings). Zone management module 532 can obtain this information and pass it along to one or more components of the BMS as follows: Space details—<Location> <Zone Name> <Workstation Number>; Schedule—<End Time of the Day>. After the information is passed to BMS, then the BMS can generate commands sing a higher priority allocation, such as <Operator Over ride>.

For example, the zone management module 532 can execute a policy to define a configurable end time of the day to be used to switch ON lighting of identified workstations, such as 4 PM. Based on the details passed and the business rule defined via the zone management module 532, following actions are carried out: lighting is kept OFF for the workstations located next to windows till 4 pm to get daylight savings; and lighting is automatically switched ON for the workstations located next to windows after 4 pm.

Still referring to FIG. 24, the process 2400 can include obtaining a schedule for daylight savings. The schedule for daylight savings can be retrieved from database 522, such as a default policy for daylight savings lighting effects established by an administrator of the system or other user. The schedule can be retrieved based on a lookup performed using information 2404. The schedule can be specific for the location, zone, workstation. The schedule can be defined as a data structure as follows: such as <location> <zone name>, <workstation number>, and <end time of the day> (2404). At 2406, the system can execute the policy to keep the lighting system off until 4 PM. At 2408, the policy 2408 can be executed, and the lights can be turned on at 2410.

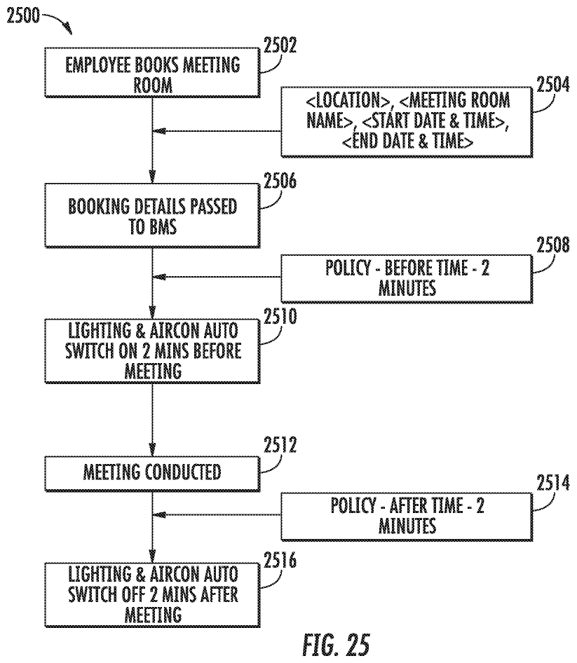

Referring now to FIG. 25, a flow chart for a process of schedule-based comfort management provided by the system depicted in FIG. 5, according to some embodiments, is shown. The process 2500 can be executed by one or more system or component depicted in FIG. 5, including, for example, the controller 506, scheduling system 512, web server 530, building subsystems 428, or user device 502. The zone management module 532 can be configured to provide schedule based space lighting & HVAC control with room booking. When a user books a meeting room, following information can be captured by the zone management module 532 and passed on to BMS: i) Space details—<Location> <Meeting Room Name>; and ii) duration of room booking—<Start Date & Time> <End Date & Time>. Once the information is passed to BMS, then the command generate can be carried out using a higher priority allocation, such as <Operator Over ride>. The zone management module 532 can provide policies that define configurable time in minutes before and after meeting to be used to switch ON/OFF lighting and air-conditioning of meeting room. For example, 2 minutes can be the defined duration. Based on the details passed and the policies 522 defined by the zone management module, the following actions can be performed via system 500: i) lighting and air-conditioning points are automatically switched ON 2 minutes before the meeting starts; and ii) lighting and air-conditioning points are automatically switched OFF 2 minutes after the meeting ends.

At 2502, the user can book a meeting room. The meeting room booking can include booking data 5204, such as a location, meeting room name, start date and time, and end date and time. At 2506, the book data or details can be passed to BMS. At 2508, the zone management module 532 can identify a policy for the meeting room, such as 2 minutes before meeting. At 2510, the zone management module 532 can turn on the lighting and air conditioning 2 minutes before the meeting begins. After the meeting is conducted at 2512, the zone management module 532, executing policy 2514, can automatically turn the lighting and air conditioning off two minutes after the meeting at 2516.

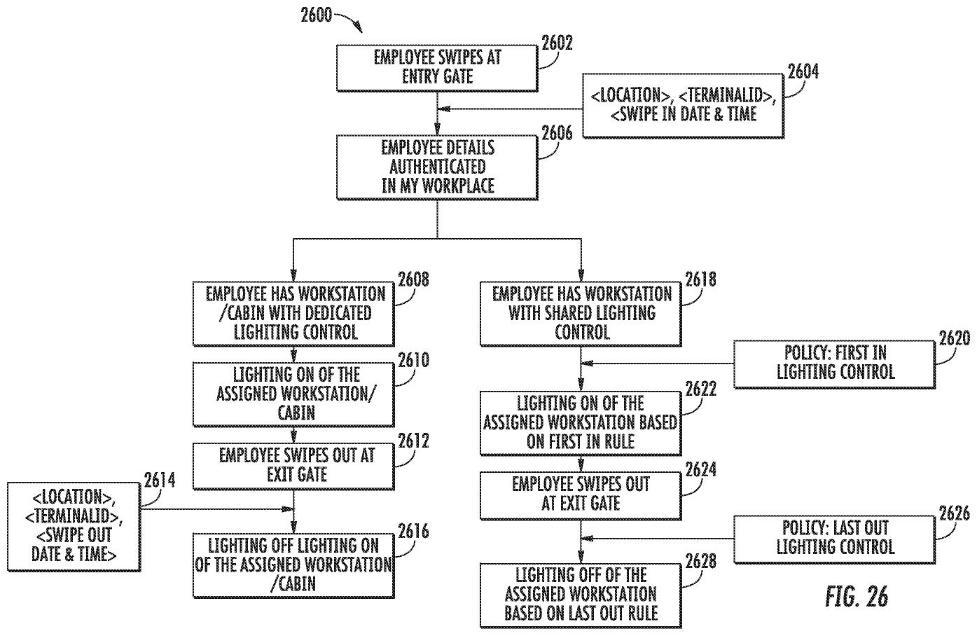

Referring now to FIG. 26, a flow chart of a process for on demand based comfort management provided by the system depicted in FIG. 5, according to some embodiments, is shown. The process 2600 can be executed by one or more system or component depicted in FIG. 5, including, for example, the controller 506, scheduling system 512, web server 530, building subsystems 428, or user device 502. The zone management module 532 can provide on demand based comfort Management. The zone management module 532 can interface with or otherwise communicate or integrate with the security system 438 to provide on demand based space lighting control. For example, when a user enters office premises and swipes his/her badge at the entry gate, then the lighting devices at the assigned workstation can switch ON automatically, and switch OFF automatically when the same user exits the office premises by swiping at the exit gate. The zone management module 532 can leverage the integration carried out with or between the BMS and security system 438. The zone management module 532 can receive the following data from the security system 538 to perform this function: i) Space details—<Location> <Terminal ID>; ii) User details—<Badge ID> <User ID>; and iii) Time details—<Swipe In Date & Time> <Swipe Out Date & Time>. The zone management module 532 can send a confirmation to BMS for on demand commanding action based on the information received from Access Control system and additional inputs as follows: <User Name> <Zone Name> <Workstation Number/Cabin Name>. After the information is passed to BMS, then the command generation can be performed using a higher priority allocation <Operator Over ride>. The zone management module 532 an provide a policy to cater to spaces where lighting control is mapped to multiple occupants. If mapping is done across multiple occupants, then the zone management module can use a First In-Last Out policy or logic (e.g., first in of any one of the multiple occupants will switch ON the lighting of the assigned workstation, and last out of remaining occupant will switch OFF the lighting of the assigned workstation).

At 2602, the employee swipes their badge at an entry gate. Data 2604 (e.g., location, terminal identifier, swipe in date and time) is provided to the zone management module 532 from the security system 438. At 2606, the employee details are authenticated by the zone management module 532. At 2608, the employee is provided with a workstation or cabin with dedicated lighting control. At 2610, the lighting is turned on at the assigned workstation. At 2612, the employee can exit. The zone management module 532 can receive, from the security system 438 responsive to the exit swipe, data 2614 (e.g., location, terminal identifier, swipe date and time). At 2616, the zone management module can turn off the lighting at the assigned workstation.

If, however, the employee has a shared workstation with shared lighting control (2618), the zone management module 532 can select a policy 2620, such as first in lighting control. At 2622, the policy can be executed to turn the lighting on at the assigned workstation based on the first in rule. At 2624, the zone management module 532 receives an indication that the employee exited. At 2626, the zone management module 532 selects the last out lighting control policy. At 2628, the zone management module 532 executes policy 2626 to turn off the lighting if the employee that exits the workstation is the last one to exit.

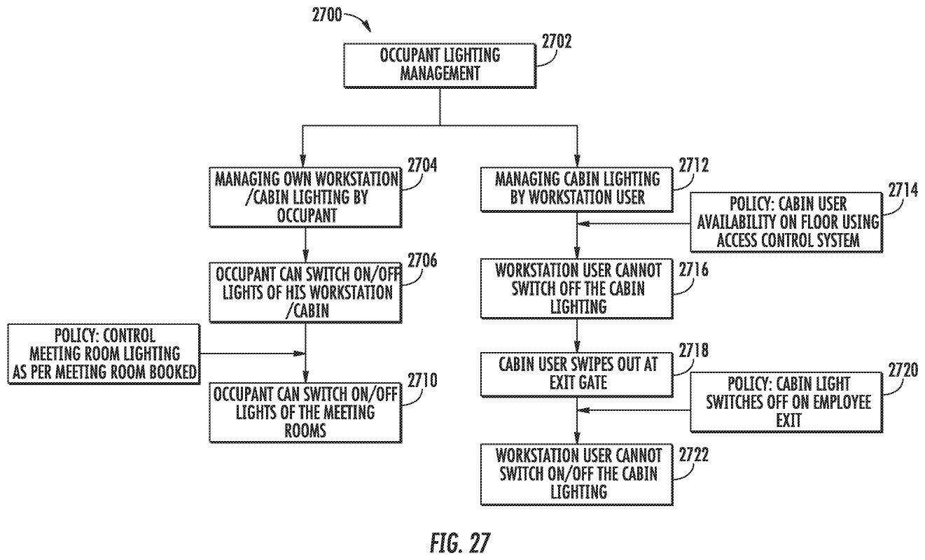

Referring now to FIG. 27, a flow chart of a process for on demand based comfort management provided by the system depicted in FIG. 5, according to some embodiments, is shown. The process 2700 can be executed by one or more system or component depicted in FIG. 5, including, for example, the controller 506, scheduling system 512, web server 530, building subsystems 428, or user device 502. The zone management module 532 can be configured to provide on demand comfort management and control based on rights assigned to the occupant such that they can control the lighting of the workstation/cabin allocated to him/her. The zone management module 532 can be configured to allow the occupant to manage their workstation/cabin lighting in following ways: i) occupant can click on the ON button under the lighting section to switch ON the lights; and ii) occupant can click on the OFF button under the lighting section to switch OFF the lights. If the lighting control is shared across multiple occupants then, zone management module 532 can implement the following policy: any occupant sharing the lighting control would not be able to switch OFF the lighting of the workstation unless he/she is the last person sitting. The zone management module 532 can be configured to allow workstation users to leverage the cabins for conducting meetings and can manage cabin lights considering following policies or rules: i) if the cabin user is within the office premise, then lighting of his/her cabin cannot be controlled. The access control system can check status on availability of cabin user on the floor; ii) if the cabin user has left from the office and has swiped out his card, then lights of his/her cabin will be automatically switched off and can be switched ON by workstation user.

At 2702, the zone management module 532 can initiate occupant lighting management. At 2704, the zone management module 532 can allow the occupant to manage their own workstation or cabin (e.g., zone). At 2706, the zone management module 532 can be configured to allow the occupant to switch on or off the lights in their zone. At 2708, the zone management module 532 can select a policy to control the meeting room lighting as per meeting room booked. At 2710, zone management module 532 can allow the occupant to switch on or off the lights of the meeting rooms.

At 2710, the zone management module 532 can allow for managing the cabin lighting by the workstation user, which may or may not be different from the occupant. At 2714, the zone management module 532 select a policy based on determining if the cabin user is available on the floor using the security system. At 2716, the zone management module 532 can block or prevent the workstation user from switching off the cabin lighting based on policy 2714. At 2718, the cabin user swipes out at exit gate. At 2720, the zone management module 532 selects a policy for switching off the cabin light on employee exit. At 2722, the zone management module 532 executes the policy to prevent the workstation user from switching off the cabin lighting.

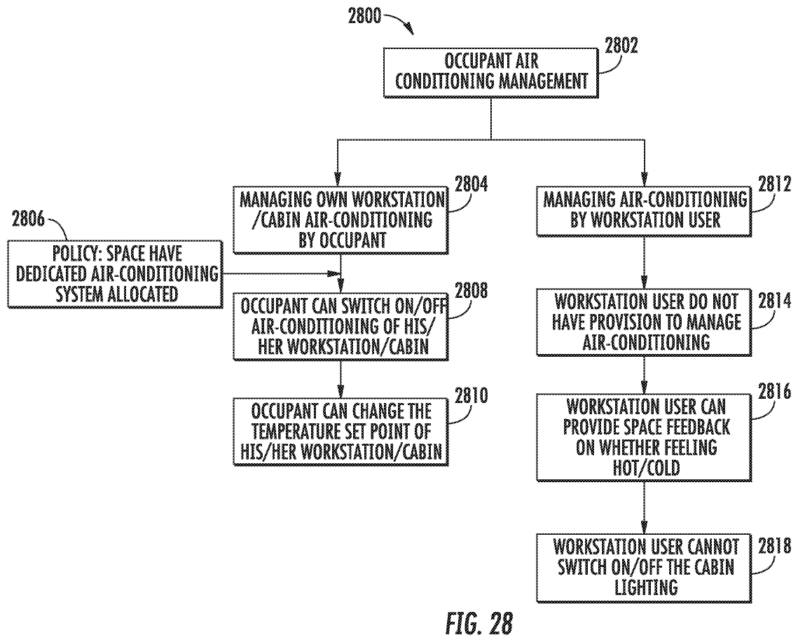

Referring now to FIG. 28, a flow chart of a process for on demand based comfort management provided by the system depicted in FIG. 5, according to some embodiments, is shown. The process 2800 can be executed by one or more system or component depicted in FIG. 5, including, for example, the controller 506, scheduling system 512, web server 530, building subsystems 428, or user device 502. The system can provide on demand based space air-conditioning control for a zone, workstation or cabin by syncing the BMS with air-conditioning management (e.g., HVAC 440). The system can determine a user's rights or the occupants rights to control the HVAC for the zone. The HVAC control can be defined on the following provisions available for space: Cabin/Workstations having dedicated air conditioning systems allocated for example: VAV boxes/VRF/Split AC units; workstations served by common air-conditioning mechanism like AHUs do not have the provision and user interface to carry out air-conditioning control.

If the occupant is authorized to control HVAC, the system can provide the following information or functionality: i) current zone temperature of the workstation/cabin allocated; ii) current temperature set point of the workstation/cabin allocated; iii) Button to switch ON/OFF the air-conditioning; and iv) text box to change the temperature set point as per occupant preference. While executing this condition, the zone management module 532 can check on the policy of temperature offset. The zone management module 532 can be configured to allow the occupant to change the temperature set point in the specified range only. For occupants who do not have the air-conditioning control, the zone management module 532 can permit them to: i) see the temperature maintained for his/her zone; ii) provide feedback on the user interface on whether occupant is feeling HOT/COLD; and iii) using this feedback determine the preference of the workstation user in each zone on the floor.

At 2802, the system initiates occupant air conditioning management. At 2804, the system determines to allow managing of the HVAC at the workstation by the occupant. The system selects policy 2806 for space dedicated to air conditioning system. At 2808, the system allow the occupant to switch on or off the A/C at the zone. At 2810, the system allow the occupant to change the temperature set point of the zone. If the A/C is managed by the workstation user, as opposed to the occupant only, such as at 2812, the process can determine the workstation user does not have the provision to manage the air conditioning at 2814. At 2816, the system provides limited information or functionality, such as feedback on whether they feel hot or cold. At 2818, the system prevents the user from switching on or off the lighting in the cabin.

Thus, the system allows user to avoid contacting facility manager/admin team to provide feedback on whether it is too hot, cold, dark, or bright. The system also allows facility managers to efficiently address multiple requests from different users that may not having a common solution. The system provides the user with the ability to control their own work environment with the click of a button switch ON/OFF lighting, or control the temperature set point of their zone (in case of dedicated air conditioning provision) or provide feedback to BMS on their HVAC preference. Thus, the systems avoids unnecessary delays while also simplifying work for facility management teams.

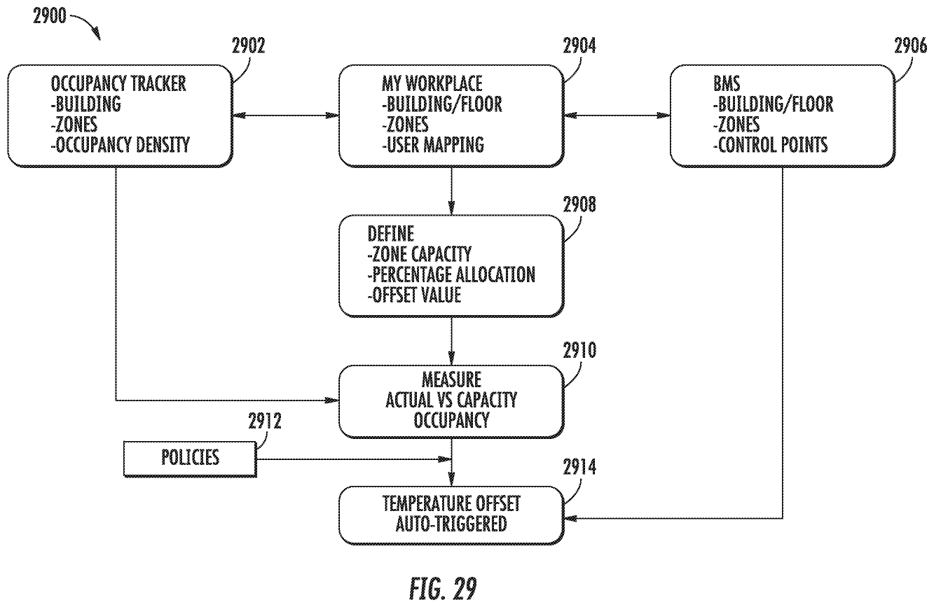

Referring now to FIG. 29, a flow chart of a process for on controlling building facilities based on occupancy detection by the system depicted in FIG. 5, according to some embodiments, is shown. The process 2900 can be executed by one or more system or component depicted in FIG. 5, including, for example, the controller 506, scheduling system 512, web server 530, building subsystems 428, or user device 502. The zone management module 532 can provide comfort management through dynamic regulation of air conditioning based on inputs taken via an occupancy tracker (e.g., security system 438) that can provide zone wise information which can be used to accurately define the air conditioning of a zone.

For example, in common areas, it can be challenging to manage comfort levels because they may cover a larger area or zone. The zone management module 532 can use rules or policies to allow users in common areas to adjust comfort levels using occupancy detection information. For example, an occupancy tracker application can determine the occupancy information and provide it to the zone management module 532, which can use it to automatic air conditioning. The system can monitor the capacity versus the actual data and automatically command the BAS system to increase or decrease the set point of the particular zone. The system can use APIs to integrate with the occupancy tracker application, or zone management module 532 or other systems or components depicted in FIG. 5, thereby facilitating maintaining the space temperature in the desired range based on the density per unit area.

At 2902, the occupancy tracker obtains information about building, zone, and occupancy density. At 2906, the BMS obtains the building, floor, zone and control points information and provides it to the zone management module 532. AT 2904, the zone management module 532 receives the information 2902 and 2906. At 2908, the zone management module 532 defines or determines the zone capacity, percentage allocation, and offset value. At 2910, the zone management module 532 can measure the actual occupancy versus the occupancy capacity (e.g., based on information 2902 from occupancy tracker). The zone management module 532 can receive policies 2912, and execute them to automatically adjust a temperature offset at 2914.

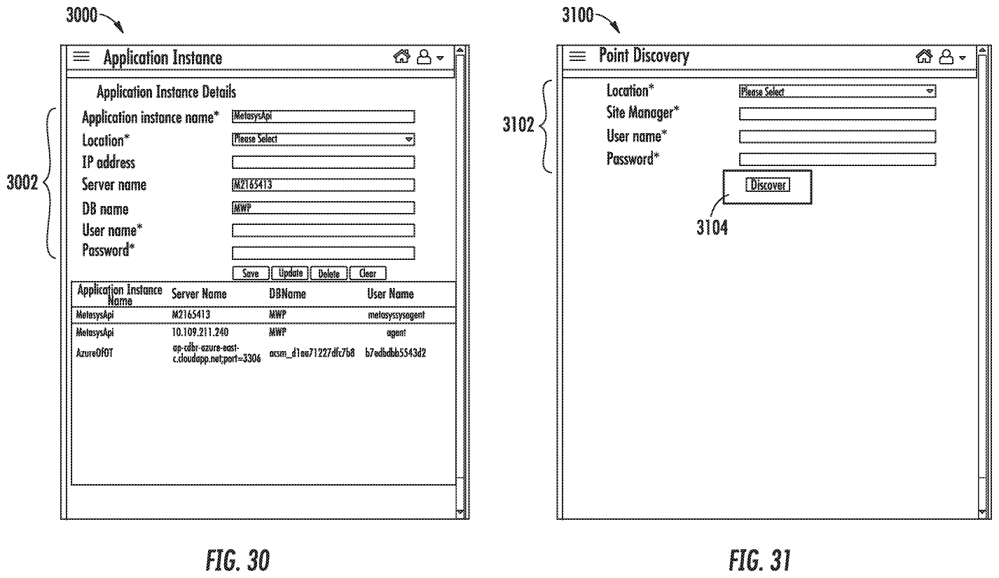

FIG. 30 is a diagram of a graphical user interface for an application for controlling building facilities based on occupancy generated by the system depicted in FIG. 5, according to some embodiments. The GUI 3000 can be provided by one or more system or component depicted in FIG. 5, including, for example, the controller 506, scheduling system 512, web server 530, building subsystems 428, or user device 502. Occupancy density information can be fetched from the occupancy tracker application and passed through one or more APIs to the zone management module 532. The BMS point list can also be fetched using APIs to provide the points used to control the AC based on the spatial density. A sync can be established and mapping defined between the different systems.

The GUI 3000 illustrates input boxes 3002, such as the instance name, location, IP address, server name, etc.

FIG. 31 is a diagram of a graphical user interface for point discovery for controlling building facilities based on occupancy generated by the system depicted in FIG. 5, according to some embodiments. The GUI 3100 can be provided by one or more system or component depicted in FIG. 5, including, for example, the controller 506, scheduling system 512, web server 530, building subsystems 428, or user device 502. The GUI 3100 illustrates point discovery information 3102, such as location, site manager, user name, password used to then perform a discover process.

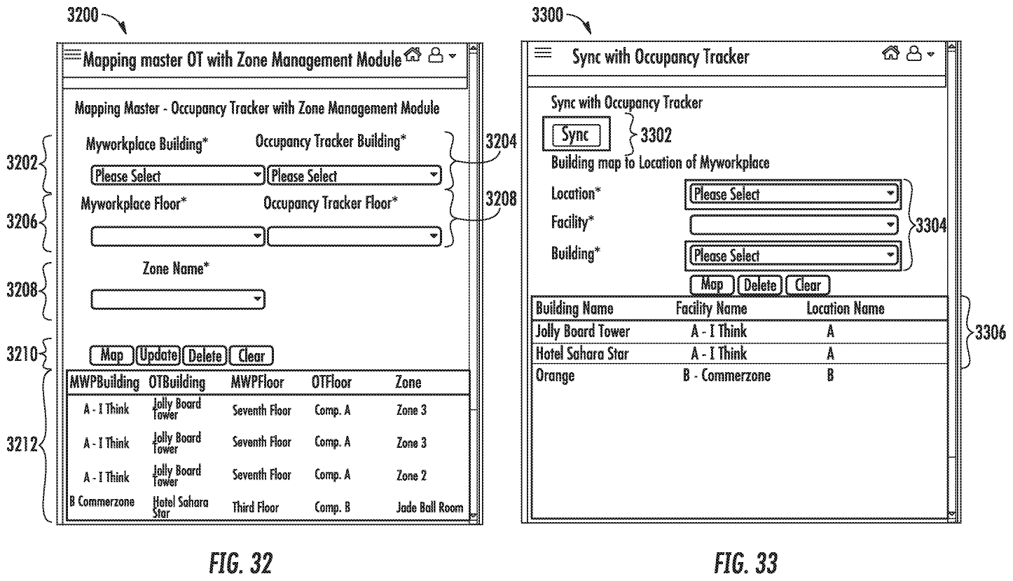

FIG. 32 is a diagram of a graphical user interface for mapping used for controlling building facilities based on occupancy generated by the system depicted in FIG. 5, according to some embodiments. The GUI 3200 can be provided by one or more system or component depicted in FIG. 5, including, for example, the controller 506, scheduling system 512, web server 530, building subsystems 428, or user device 502. As illustrated by 3202, 3206, and 3208, the system can map spatial mapping across the occupancy tracking and the zone management module. A sync is established, and mapping is defined across the two systems. The defined buildings can be mapped to a location in the zone management module 532, and a one-to-one mapping can be done between buildings and floors for both application. The zones can be added in accordance with the nomenclature established by the occupancy tracker. The system can be updated using buttons 3210. The mapping list can be displayed 3212.

FIG. 33 is a diagram of a graphical user interface for syncing used for controlling building facilities based on occupancy generated by the system depicted in FIG. 5, according to some embodiments. The GUI 3300 can be provided by one or more system or component depicted in FIG. 5, including, for example, the controller 506, scheduling system 512, web server 530, building subsystems 428, or user device 502. Selecting sync button 3302 can begin the sync for the location 3304, which can result in list 3306.

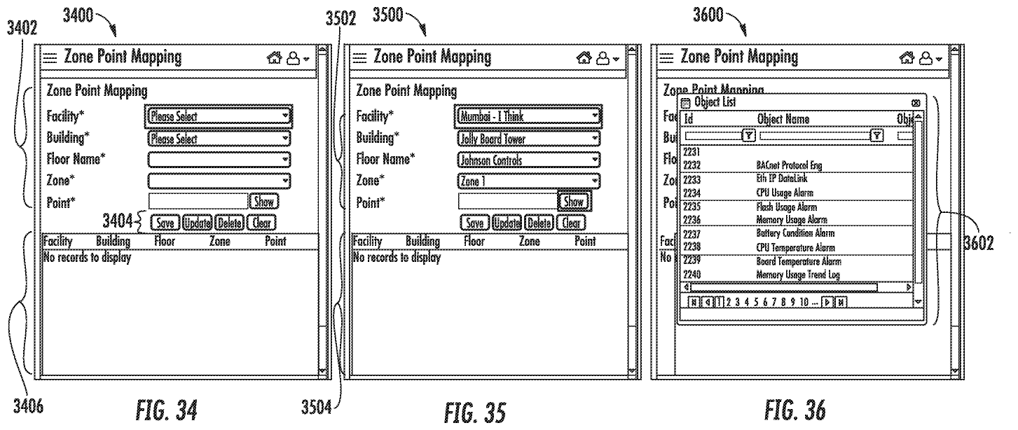

FIG. 34 is a diagram of a graphical user interface for zone point mapping used for controlling building facilities based on occupancy generated by the system depicted in FIG. 5, according to some embodiments. The GUI 3400 can be provided by one or more system or component depicted in FIG. 5, including, for example, the controller 506, scheduling system 512, web server 530, building subsystems 428, or user device 502. GUI 3400 illustrates the zone point mapping inputs 3402, and selection buttons 3404, and results 3406.

FIG. 35 is a diagram of a graphical user interface for zone point mapping used for controlling building facilities based on occupancy generated by the system depicted in FIG. 5, according to some embodiments. The GUI 3500 can be provided by one or more system or component depicted in FIG. 5, including, for example, the controller 506, scheduling system 512, web server 530, building subsystems 428, or user device 502. GUI 3500 can illustrate inputs 3502 into the zone point mapping interface, and results 3504.

FIG. 36 is a diagram of a graphical user interface for zone point mapping used for controlling building facilities based on occupancy generated by the system depicted in FIG. 5, according to some embodiments. The GUI 3600 can be provided by one or more system or component depicted in FIG. 5, including, for example, the controller 506, scheduling system 512, web server 530, building subsystems 428, or user device 502. GUI 3600 illustrates a pop-up window with an object list 3602.

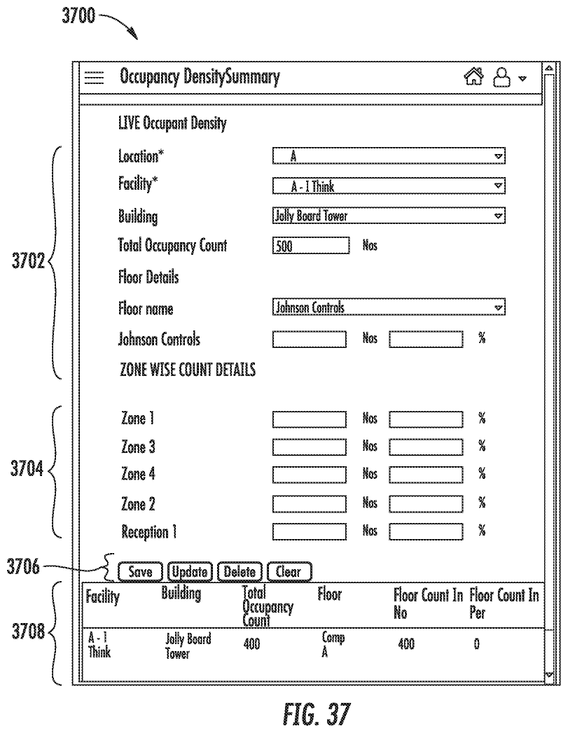

FIG. 37 is a diagram of a graphical user interface for occupancy density used for controlling building facilities based on occupancy generated by the system depicted in FIG. 5, according to some embodiments. The GUI 3700 can be provided by one or more system or component depicted in FIG. 5, including, for example, the controller 506, scheduling system 512, web server 530, building subsystems 428, or user device 502. GUI 3700 includes a configuration summary for live occupant density information 3702, zone information 3704, selection buttons 3706, and results 3708.

For example, post syncing of two systems, definition of zones and mapping of points to zones, the next step can be to test the occupancy information coming from the occupancy tracker to determine if the information is displaying correctly. For the calculations to work, capacity values can be defined against each zone to measure the Actual Zone Occupancy count Vs Zone Capacity. Total Capacity of the floor can be provided for calculating the distribution across different zones on the floor. Zone capacity can be entered in numbers and the system can auto calculate the percentage impact for it. For example, Total Occupancy Count—500, Zone 1—100; Zone 2—100; Zone 3—100; Zone 4—100; Zone 5—100. Each Zone can have 20% contribution to total occupancy. This can be auto calculated and change as the capacity value gets updated. Calculations can be considered for both increase & decrease in zone occupancy against capacity. The occupancy value coming from OT for zone can be considered as 100%. For example, if Zone Capacity is 100 and Actual Value coming from OT is 100 then it is taken as 100%; If Zone capacity is 100 and Actual Value coming from OT is 80 then it is 80% occupancy; and If Zone capacity is 100 and Actual Value coming from OT is 120 then it is 120% occupancy.

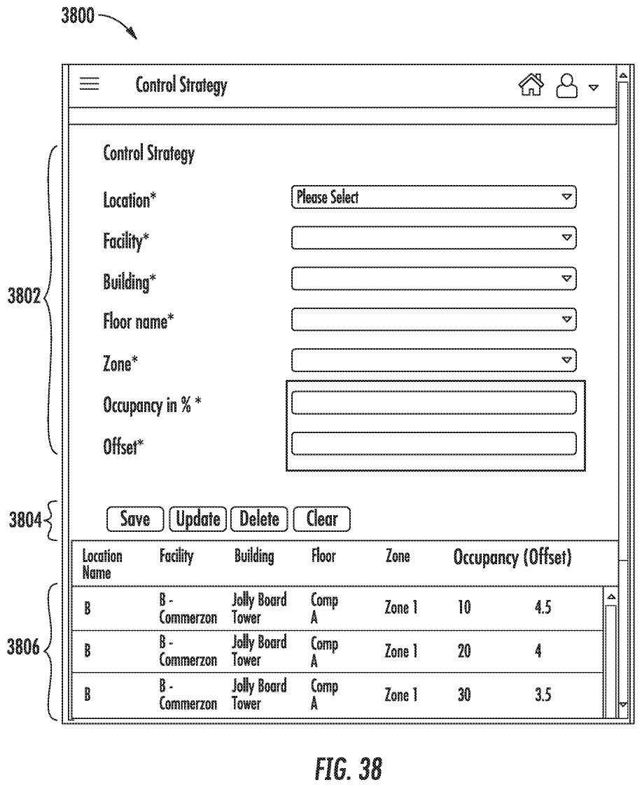

FIG. 38 is a diagram of a graphical user interface for controls used for controlling building facilities based on occupancy generated by the system depicted in FIG. 5, according to some embodiments. The GUI 3800 can be provided by one or more system or component depicted in FIG. 5, including, for example, the controller 506, scheduling system 512, web server 530, building subsystems 428, or user device 502. After assignment of percentage distribution, final step can be to allocate the control (temperature offset) to carry out as per the percentage increase or decrease recorded per zone on floor. For each zone based on the percentage, offset value can be defined which can automatically be executed by the system in sync with BMS system. Temperature offset can be the set point change that is triggered based on the actual occupancy data coming from OT and calculations done in the system. For example: Total Occupancy Count—500, then: Zone 1 Capacity—100; Actual Value recorded by OT—120; Zone 1 has 120% occupancy; Offset defined for 10% is 1 deg C. Since there is 20% greater occupancy than the normal capacity, the temperature offset can be a 2 degree decrease in temperature so that the zone temperature can be maintained and people are not hot. The set point can be reduced by 2 deg C. If it was 22 deg C. then it will become 20 deg C. To improve efficiency, policies can be used to account for time difference between two subsequent offsets. The control strategy GUI 3800, accordingly, can include control strategy information 3802 input, selection buttons 3804, and results 3806. Thus, the system can provide centralized air conditioning that can be efficiently managed for employees sitting in larger work spaces and help address comfort issues raised by employees through the integration of the different systems (e.g., zone management module 532, BMS, policies, and occupancy tracker applications). The system can provide dynamic auto regulation in response to real-time conditions, thereby avoiding delays and causing excess processes.

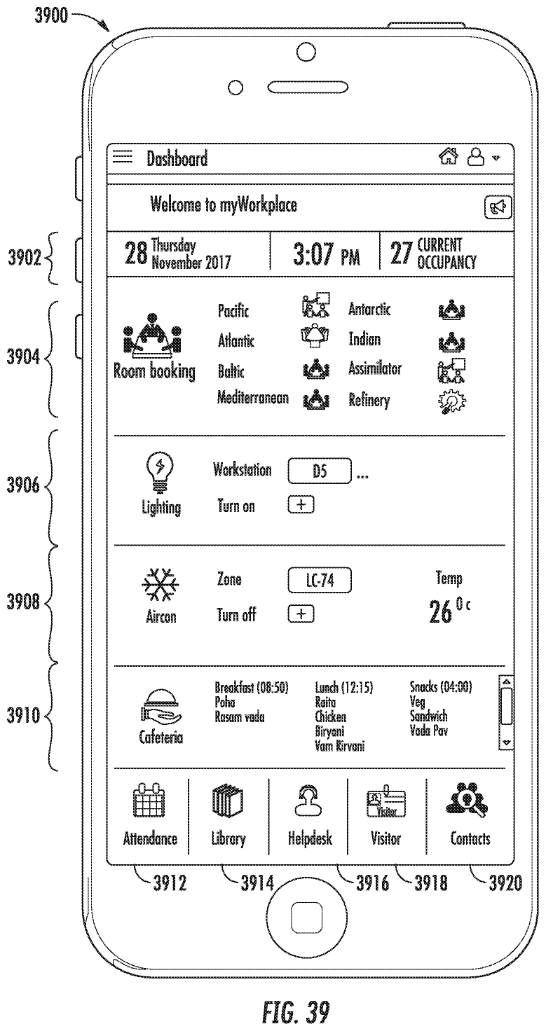

FIG. 39 is a diagram of a graphical user interface for a dashboard generated by the system depicted in FIG. 5, according to some embodiments. GUI 3900 includes day, time and occupancy information 3902, room booking information 3904, device controls 3906, HVAC controls 3908, cafeteria requests 3910, and buttons to access attendance GUI 3912, library GUI 3914, helpdesk GUI 3916, visitor GUI 3918, and contacts GUI 3920.

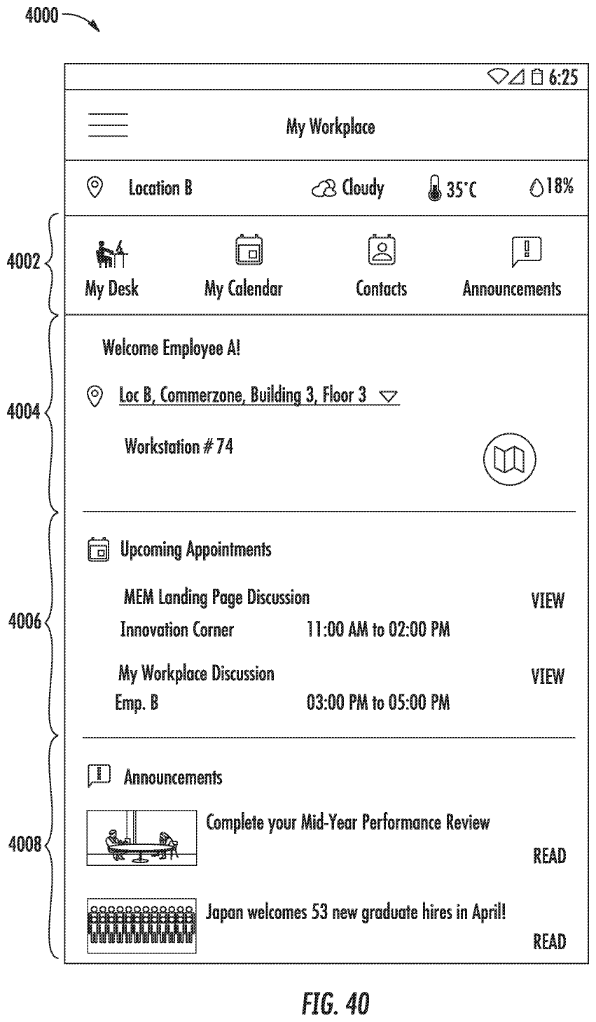

FIG. 40 is a diagram of a graphical user interface for announcements generated by the system depicted in FIG. 5, according to some embodiments. GUI 4000 includes buttons 4002 to access my desk, calendar, contacts, and announcements screens; location information 4004; calendar appointments 4006, and announcements 4008, which can be fetched from system 500.

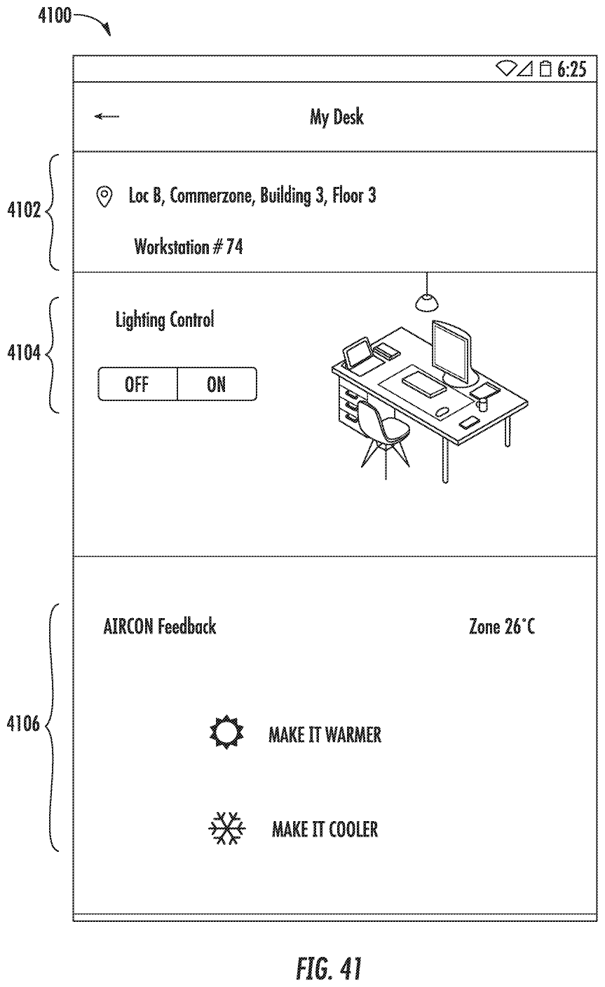

FIG. 41 is a diagram of a graphical user interface for zone information generated by the system depicted in FIG. 5, according to some embodiments. GUI 4100 provides location information 4102; lighting controls 4104, and HVAC controls 4106.

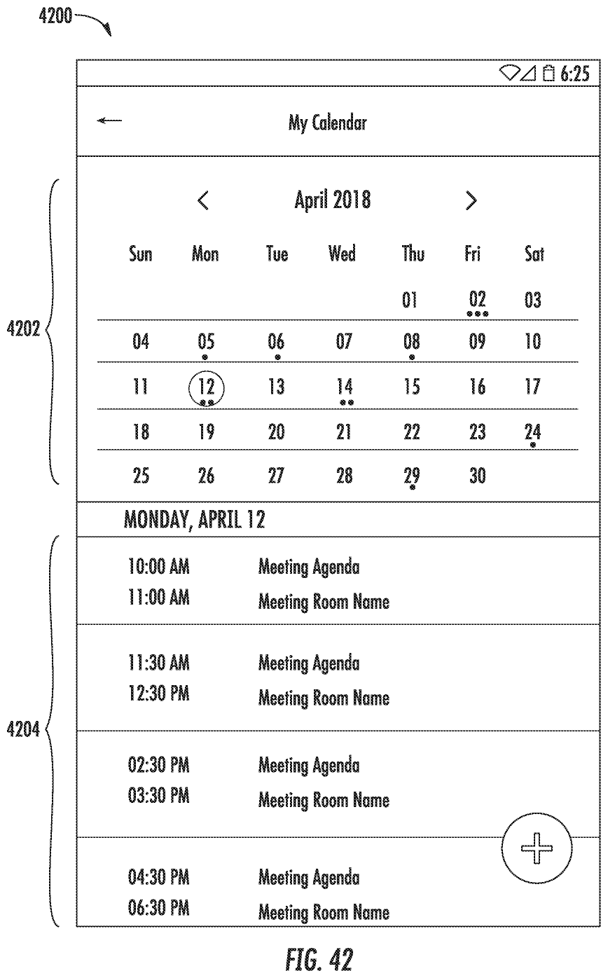

FIG. 42 is a diagram of a graphical user interface for a calendar generated by the system depicted in FIG. 5, according to some embodiments. GUI 4200 includes calendar information 4202, and event information 4204.

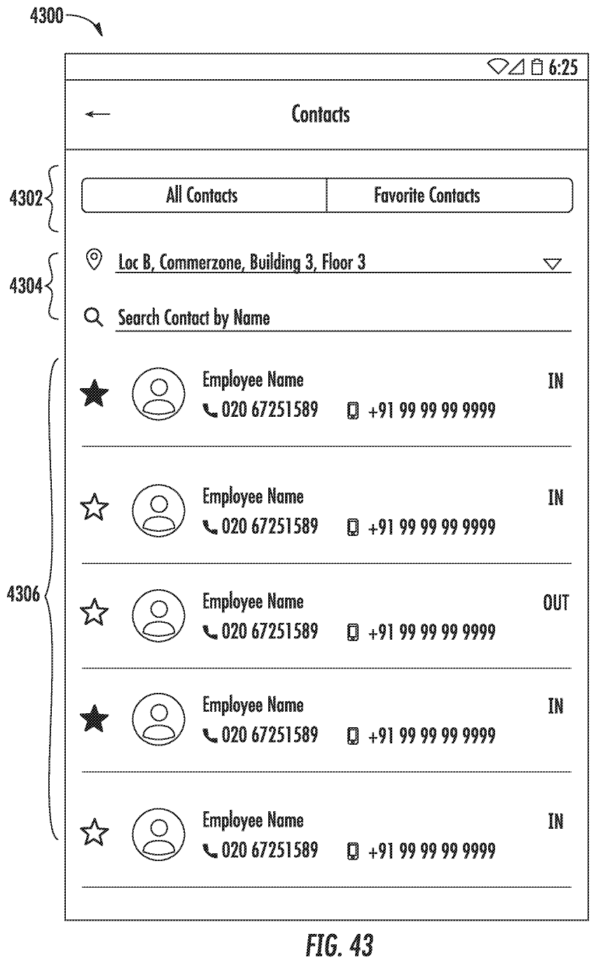

FIG. 43 is a diagram of a graphical user interface for contacts generated by the system depicted in FIG. 5, according to some embodiments. GUI 4300 includes all contacts or favorite contacts information 4302; contact search based on location 4304; and contact search results 4306.

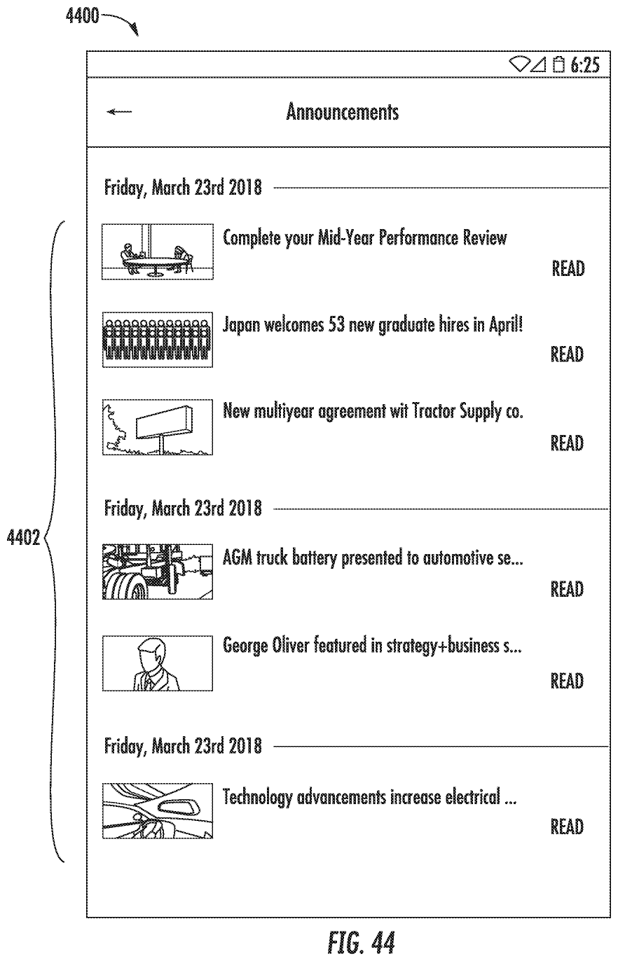

FIG. 44 is a diagram of a graphical user interface for announcements generated by the system depicted in FIG. 5, according to some embodiments. GUI 4400 includes announcements 4402 fetched from various systems integrated or in communication with system 500.

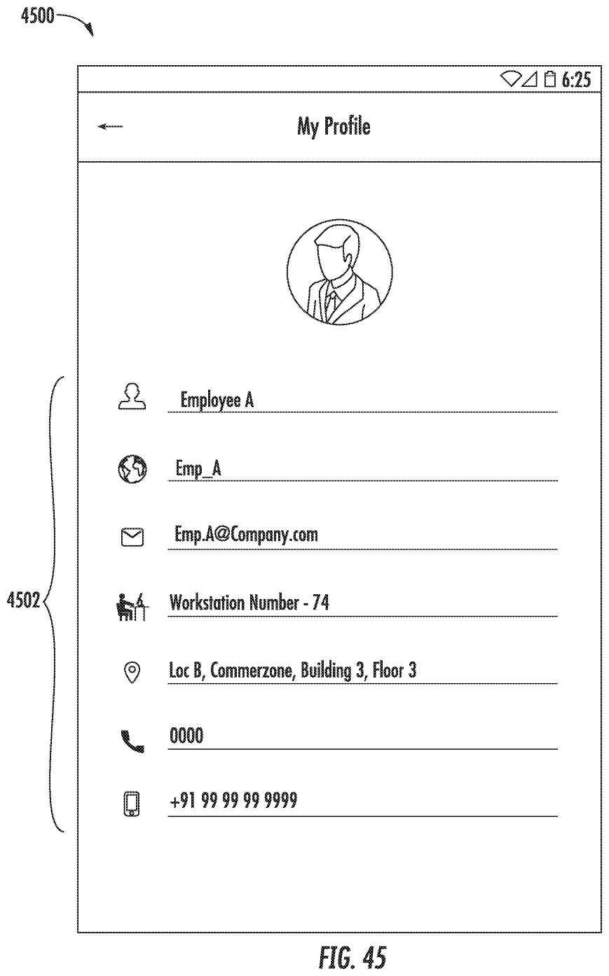

FIG. 45 is a diagram of a graphical user interface for a profile generated by the system depicted in FIG. 5, according to some embodiments. GUI 4500 includes a user's profile with profile information 4502.

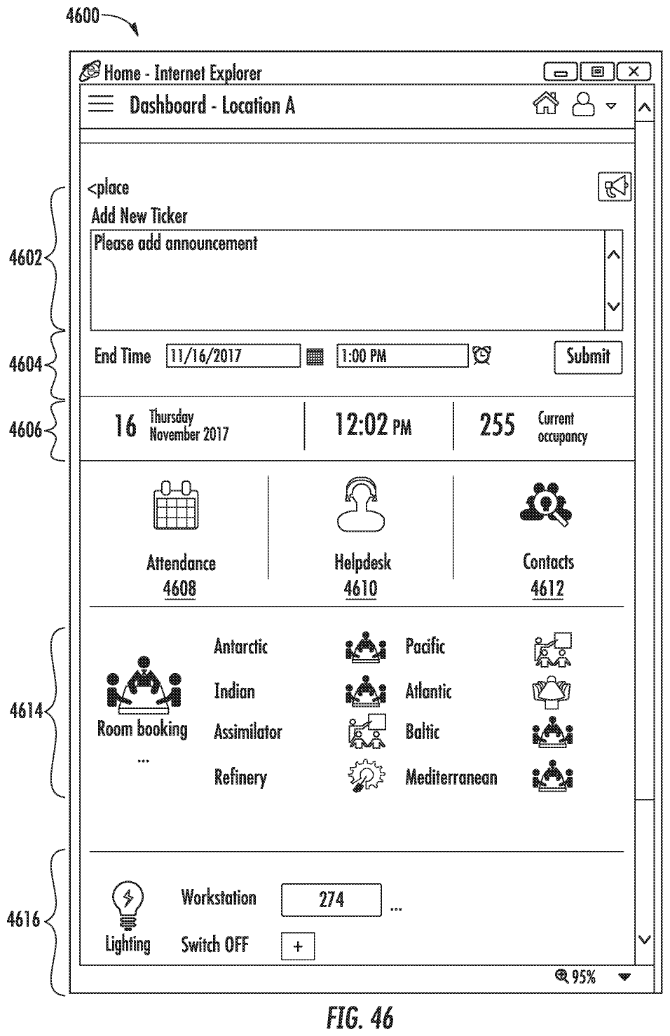

FIG. 46 is a diagram of a graphical user interface for a dashboard generated by the system depicted in FIG. 5, according to some embodiments. GUI 4600 includes a dashboard of a location. An announcement can be created for at input 4602 with end time information 4604. The current day, time and occupancy for location A can be displayed in field 4606. Room booking information can be provided in field 4614. Lighting controls can be displayed in field 4614.

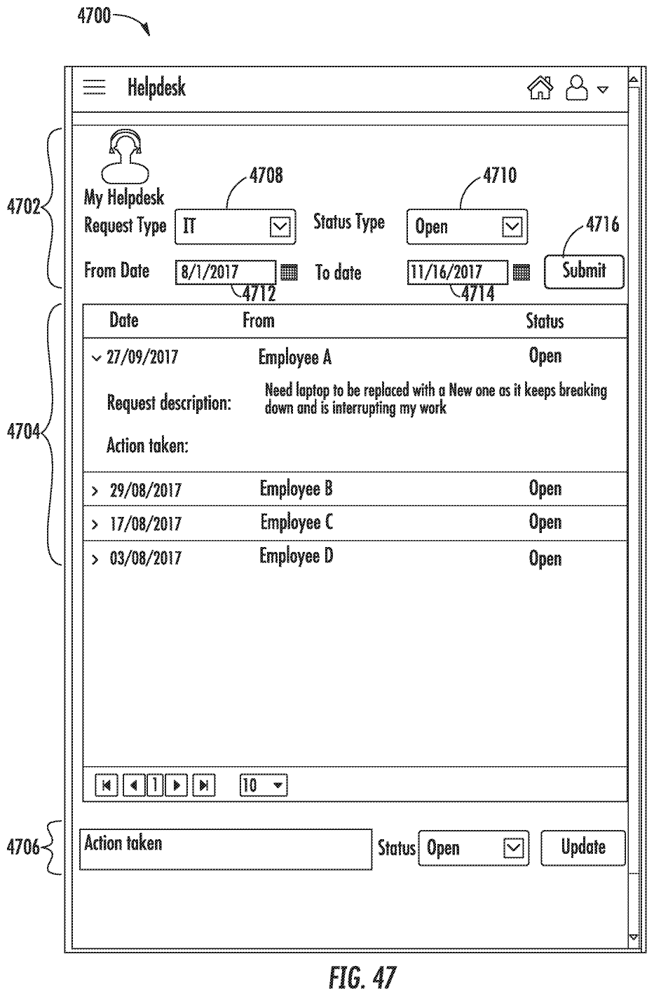

FIG. 47 is a diagram of a graphical user interface for a help desk generated by the system depicted in FIG. 5, according to some embodiments. GUI 4700 includes fields 4702 to view a helpdesk request ticket, such as request type 4708, status 4710, from ate 4712, and to date 4714, and a submit button 4716. Helpdesk search results 4704 can be provided responsive to submit button 4716 being selected. The ticket can be updated via field 4706 to indicate whether action was taken.

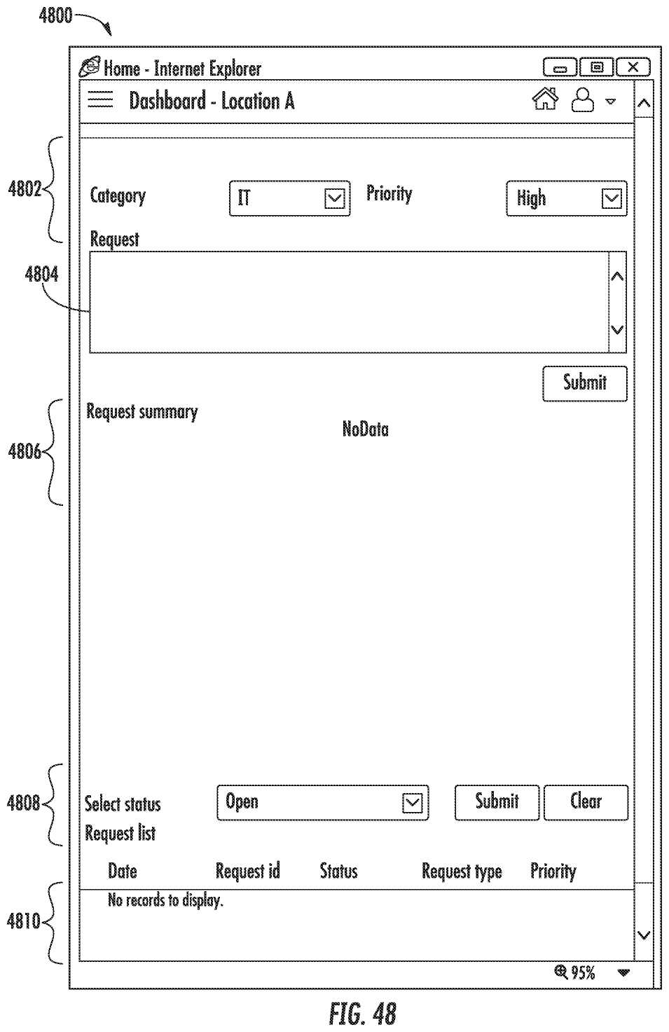

FIG. 48 is a diagram of a graphical user interface for a dashboard generated by the system depicted in FIG. 5, according to some embodiments. Fields 4802 and 4804 can be used to generate a helpdesk request. Request summary 4806 can indicate information about the request. Field 4808 can provide status information, and search results can be displayed in field 4810.

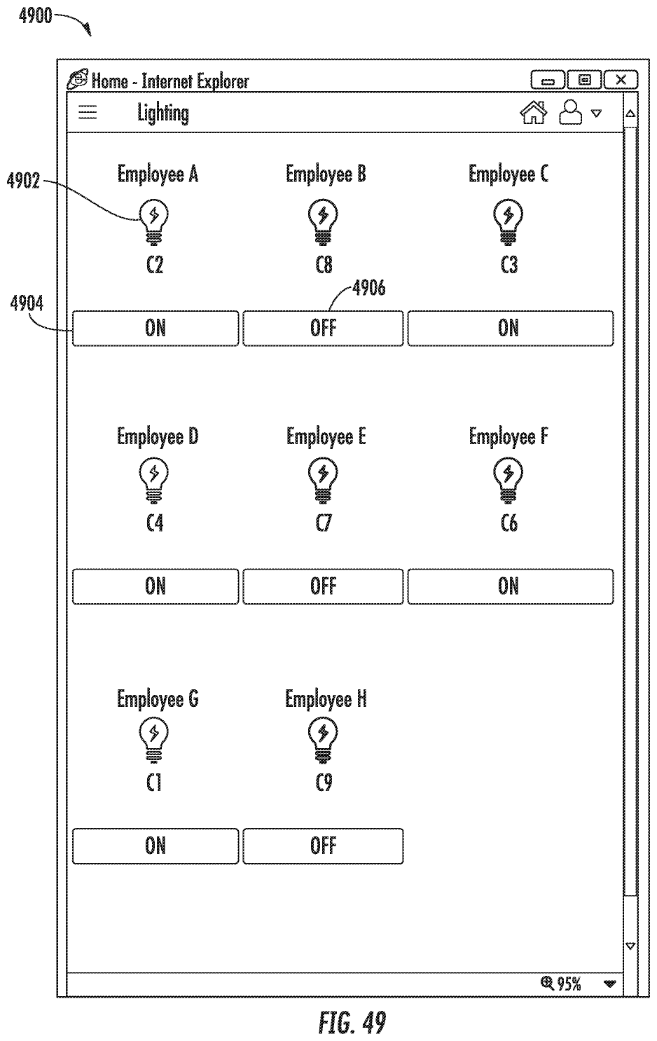

FIG. 49 is a diagram of a graphical user interface for lighting generated by the system depicted in FIG. 5, according to some embodiments. Lighting controls for employee A 4902 are displayed, with buttons 4904 to turn on or off the lights for each employee (e.g., 4904 and 4906).

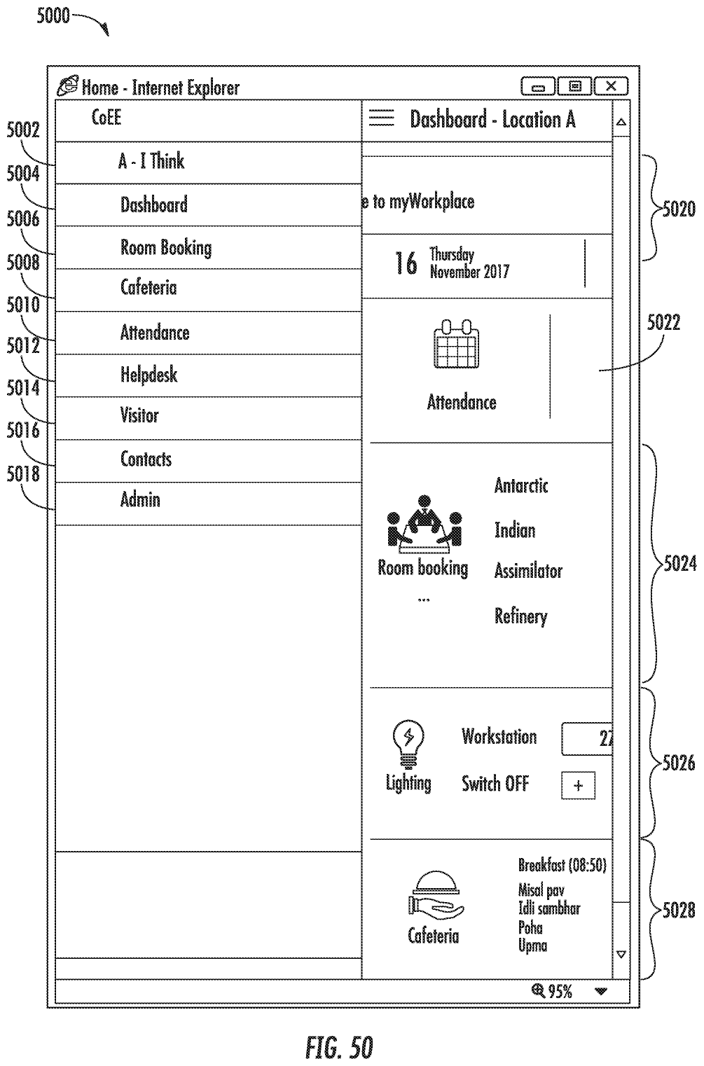

FIG. 50 is a diagram of a graphical user interface for a dashboard generated by the system depicted in FIG. 5, according to some embodiments. GUI 5000 includes buttons to access various GUIs or systems at location A 5002, including, for example, dashboard 5004, room booking 5006, cafeteria 50089, attendance 5010, helpdesk 5012, visitor info 5014, contacts 5016, and administration 5018. Fields 5020, 5022, 5024, 5026 and 5028 depicts aspects of the dashboard in the background.

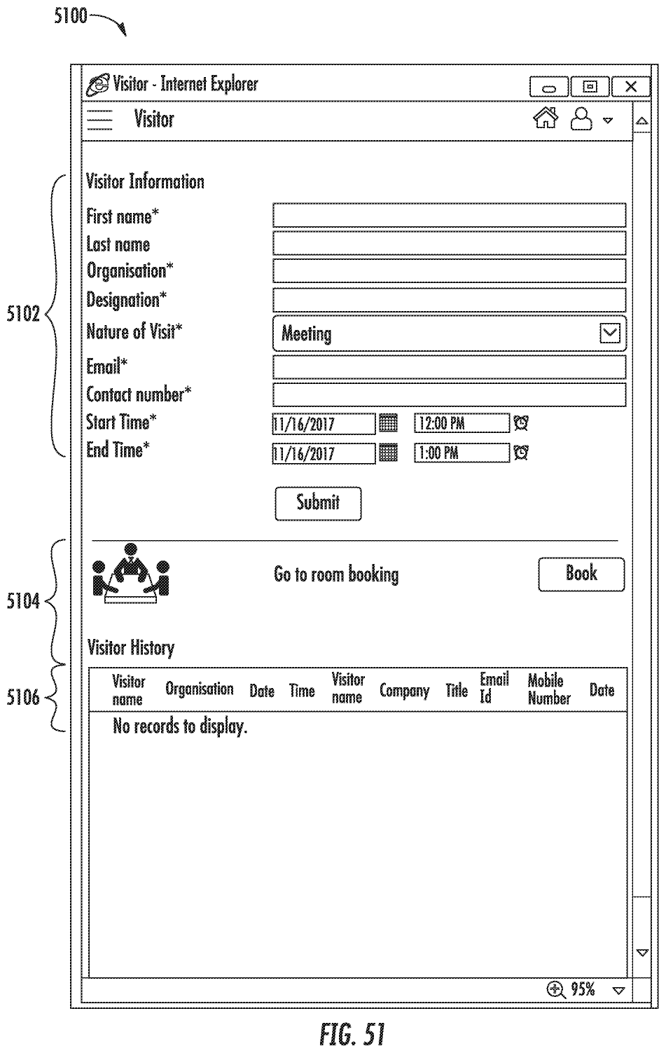

FIG. 51 is a diagram of a graphical user interface for a visitor screen generated by the system depicted in FIG. 5, according to some embodiments. The visitor GUI 5100 can include fields 5102 to input visitor information, book rooms 5104 for the visitor, and visitor history 5106.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system for zone-based control of devices within a building management system (BMS), the system comprising:
a user device comprising at least one processor and a display;
a zone device comprising at least one processor and an input interface; and
a controller of a building management system, the controller comprising at least one processor configured to:
receive, from the user device via a network, a request to control a zone in a building, the request comprising at least one data structure formed from a date field, a time field, a location field, a zone type field, and a resource field;
identify, responsive to the request, a plurality of available zones in the building;
receive, from the user device, a selection to control a first zone from the plurality of available zones;
generate, responsive to the selection, a password to restrict control of at least one device in the first zone;
transmit, to the user device, the password;
receive, via the input interface of the zone device different from the user device, the password, the zone device located in the first zone; and
authorize, responsive to receipt of the password via the input interface of the zone device, control of the at least one device in the first zone.

2. The system of claim 1, wherein the controller is further configured to:
retrieve, from a database, a policy for controlling the at least one device; and
execute the policy at a predetermined time interval prior to a start time indicated in the time field of the at least one data structure of the request.

3. The system of claim 1, wherein the controller is further configured to generate a command to adjust a temperature set point for the first zone at a predetermined time interval prior to a start time indicated in the time field of the at least one data structure of the request.

4. The system of claim 1, wherein the controller is further configured to:
detect an occupancy level of the first zone; and
override a temperature set point responsive to the occupancy level exceeding a threshold established in a database for the first zone.

5. The system of claim 1, wherein the controller is further configured to:
generate a time interval based on a start time and an end time indicated by the time field of the at least one data structure of the request; and
authorize control of the at least one device responsive to receipt of the password via the input interface of the zone device at a time within the time interval.

6. The system of claim 1, wherein the controller is further configured to:
generate a time interval based on a start time and an end time indicated by the time field of the at least one data structure of the request; and
prevent control of the at least one device responsive to receipt of the password via the input interface of the zone device at a time outside the time interval.

7. The system of claim 1, wherein the resource field indicates a projector, a computing device, a telecommunications device, or a printer; and
the controller is further configured to identify the plurality of available zones based on the resource field, the plurality of available zones satisfying the resource field.

8. The system of claim 1, wherein the at least one device in the first zone comprises a projector, a motorized projector screen, a lighting device, a computing device, a temperature controller, a telecommunication device, or a printer.

9. The system of claim 1, wherein the controller is further configured to:
receive an occupancy indication for the request based on a calendar entry stored in a scheduling system separate from the building management system; and
identify, based on a predetermined occupancy limit stored in a database for each of a plurality of zones in the building, the plurality of available zones that satisfy the occupancy indication.

10. The system of claim 1, wherein the controller is further configured to:
receive, from the user device, a list of identifiers authorized to access the first zone during a time interval based on the date field and the time field provided in the at least one data structure;
receive, from an access control panel at the first zone, an identifier responsive to a badge swipe at the access control panel during the time interval,
determine the identifier matches the list of identifiers; and
unlock, responsive to the determination, a remotely controlled lock to allow access to the first zone.

11. A method of zone-based control of devices within a building management system (BMS), the method comprising:
receiving, from a user device via a network, a request to control a zone in a building, the request comprising at least one data structure formed from a date field, a time field, a location field, a zone type field, and a resource field;
identifying a plurality of available zones in the building;
receiving, from the user device, a selection to control a first zone from the plurality of available zones;
generating, responsive to the selection, a password to restrict control of at least one device in the first zone;
transmitting, to the user device, the password;
receiving, via the input interface of the zone device different from the user device, the password, the zone device located in the first zone; and
authorizing, responsive to receipt of the password via the input interface of the zone device, control of the at least one device in the first zone.

12. The method of claim 11, further comprising:
retrieving, from a database, a policy for controlling the at least one device; and
executing the policy at a predetermined time interval prior to a start time indicated in the time field of the at least one data structure of the request.

13. The method of claim 11, further comprising generating a command to adjust a temperature set point for the first zone at a predetermined time interval prior to a start time indicated in the time field of the at least one data structure of the request.

14. The method of claim 11, further comprising:
detecting an occupancy level of the first zone; and
overriding a temperature set point responsive to the occupancy level exceeding a threshold established in a database for the first zone.

15. The method of claim 11, further comprising:
generating a time interval based on a start time and an end time indicated by the time field of the at least one data structure of the request; and
authorizing control of the at least one device responsive to receipt of the password via the input interface of the zone device at a time within the time interval.

16. The method of claim 11, further comprising:
generating a time interval based on a start time and an end time indicated by the time field of the at least one data structure of the request; and
preventing control of the at least one device responsive to receipt of the password via the input interface of the zone device at a time outside the time interval.

17. The method of claim 11, wherein the resource field indicates a projector, a computing device, a telecommunications device, or a printer; and
the method further comprises identifying the plurality of available zones based on the resource field, the plurality of available zones satisfying the resource field.

18. The method of claim 11, wherein the at least one device in the first zone comprises a projector, a motorized projector screen, a lighting device, a computing device, a temperature controller, a telecommunication device, or a printer.

19. The method of claim 11, further comprising:
receiving an occupancy indication for the request based on a calendar entry stored in a scheduling system separate from the building management system; and
identifying, based on a predetermined occupancy limit stored in a database for each of a plurality of zones in the building, the plurality of available zones that satisfy the occupancy indication.

20. The method of claim 11, further comprising:
receiving, from the user device, a list of identifiers authorized to access the first zone during a time interval based on the date field and the time field provided in the at least one data structure;
receiving, from an access control panel at the first zone, an identifier responsive to a badge swipe at the access control panel during the time interval,
determining the identifier matches the list of identifiers; and
unlocking, responsive to the determination, a remotely controlled lock to allow access to the first zone.
